(19) United States
(12) Patent Application Publication
(10) Pub. No.: US 2005/0216394 A1
(43) Pub. Date: Sep. 29, 2005

(54) Computer-based system and method for confirming failed trades of securities

(76) Inventors: Leonard C. Monteleone, Boca Raton, FL (US); James Fiorentino, Calabasas, CA (US)

Correspondence Address: TORYS LLP, 79 WELLINGTON ST. WEST, SUITE 3000, TORONTO, ON, M5K 1N2, CA

(21) Appl. No.: 11/131,287

(22) Filed: May 18, 2005

Related U.S. Application Data
(63) Continuation-in-part of application No. 10/735,749, filed on Dec. 16, 2003.

(51) Int. Cl. G06F 17/60

(52) U.S. Cl. 705/37

(57) ABSTRACT

The present invention provides a novel system and method for confirming failed trades. In securities trading, and particularly mortgage backed securities trading, there can be a desire to provide market liquidity by allowing trading of securities by parties, even where party does not actually have the securities necessary to satisfy the trade, on the view that the party will acquire the necessary securities to satisfy the trade in advances of the settlement date. However, market instability can result from actual failures to satisfy the trade. The present system and method provide a means for reducing such instability by confirming such failed trades.

### PRIORITY CLAIM

The present application is a continuation-in-part of U.S. Non-Provisional patent application Ser. No. 10/735,749, filed on Dec. 16, 2003, and claims priority from a U.S. Provisional Patent Application, filed on May 16, 2005, entitled “Fail Management of Mortgage Backed Securities”, application number not yet assigned, both of which are incorporated herein by reference.

### FIELD OF THE INVENTION

The present invention relates to electronic trading systems and more particularly relates to a computer-based system and method for confirming failed trades of securities and their settlement.

### BACKGROUND OF THE INVENTION

Automated trading is offered in many different markets, and is a well known means of matching orders to buy and sell items in the market, and then executing those matched orders.

In an electronic stock exchange, firms act on behalf of clients that are interested in buying or selling a security. (As used herein, the term “firm” refers to brokers, dealers, agents, institutions, traders, or the like whether individual or associated in groups or other entities. Such terms may be used interchangably as the context of such usage allows or requires.) The firm will interact with the electronic stock exchange via work stations where they place their orders to buy or sell securities on behalf of their clients. On execution of an order, a transaction fee is typically charged to the buying client and the selling client by both the buy-side firm and the sell-side firm.

Securities trading has benefited enormously from automated processing and settlement using computers. However, securities come in many different forms and so different automation techniques are used for different forms of securities. Generally, high demand securities, such as mutual funds, stocks and bonds, have undergone greater trading automation than others.

One class of securities that is increasingly in demand is mortgage-backed securities (“MBS”). In the year 2003, there have been times that the outstanding debt in the MBS industry has exceeded $3.0 trillion. Despite this demand, the processing and settlement techniques for MBS have remained relatively static over the last twenty-five years. As demand for MBS increases, there have increasingly been industry-wide delays and failures in transaction settlements.

Currently, MBS trades are processed in the following manner. Initial trades are done on a to-be-announced (“TBA”) basis, wherein the government agency, coupon, price and settlement date are identified (“TBA trade” or “Generic trade”). On the settlement date, the TBA trade is “pooled”, or converted into a specific pool trade that is identified with a unique pool number. The Government National Mortgage Association (“GNMA” or “Ginnie Mae”), the Federal National Mortgage Association (“FNMA” or “Fannie Mae”) and the Federal Home Loan Mortgage Corp (“FHLMC” or “Freddie Mac”) are three Agencies that package their mortgages into specific securities that are sold as specific pool securities in the over-the-counter (“OTC”) marketplace.

A specific example helps to further understand the foregoing prior art method of processing MBS trades. An example of a TBA trade or Generic trade is a GNMA, 6.0%, $1 million, for settlement on Jul. 15, 2003. More particularly, GNMA is the Agency, 6.0% is the Coupon, $1 million is the value of the trade, and Jul. 15, 2003 is the settlement date. This TBA trade, in turn, will settle into a specific pool trade as of Jul. 15, 2003. The specific pool trade will detail the pool number and the current value of the pool. Those of skill in the art will recognize that, in this example, industry guidelines specify that three pools, each having a minimum original face value of $25,000 but collectively totalling $1 million, and within a variance of plus or minus 0.01%, will be considered a “good” delivery of this TBA trade.

To effect the conversion of TBA trades into specific pool trades, the industry has adopted a forty-eight hour rule that is designed to facilitate the exchange of trading details in the forty-eight hour period prior to the settlement date. Unfortunately, many firms tend to exchange such trading details late, and therefore, many firms experience processing delays in handling these conversions.

Further problems with trades and settlements thereof are experienced by the buy-side firms and their custodial banks, who also experience processing delays and errors in handling the volume of pools during the forty-eight hour period. To reduce volume, buy-side firms are requesting larger pool sizes. While larger pool sizes do reduce the amount of processing on settlement, the overall trade price tends to increase for the buyer.

A still further problem arises with the need for buy-side firms to maintain sub- accounts for certain customers - such as pension funds, corporate trusts, insurance companies, etc. The management of sub-accounts further increases the processing load of transactions of MBS in each account. For example, a $500 million TBA trade may in fact represent settlement of more than a thousand individual sub-accounts and correspond to more than a thousand clearance events. Such a $500 million TBA trade may therefore be broken into a number of pieces, compounding the problem. While a buy-side firm can hold the same pool in all sub-accounts, it cannot combine these pools due to existing laws. Buy side firms need to coordinate their settlement activities with numerous custodial banks in an effort to complete the settlement process. However, due to failed trades, these buy side firms need to reconcile their internal records in accordance with their custodial banks. Just reconciling the settled trades vs. the failed trades is a major undertaking.

In particular failed trades lead to increased capital requirements, market risk, counterparty exposure due to potential counterparty-insolvency and regulatory and compliance issues.

Other problems also currently exist in the MBS industry. In particular, failed trades often lead to a so-called “round robin” scenario wherein in lieu of securities being exchanged to settle the trades, a funds settlement is shifted from one financial institution to another. While this can help a financial institution to temporarily deal with a failed trade, it is not a permanent answer. Round robins particularly arise in the context of the MBS industry due to the allocation of pool issues. For example, financial institution A sells to financial institution B, which in turn sells to financial institution C and so on, where the final transaction returns the securities to the institution making the initial sale. If, however, there is a delay in the initial firm making delivery, then the ripple effect of failed deliveries reverberates throughout the industry. This has placed an undue burden on the operation staffs of both buy- and sell-side firms. The net result can be seen in the growing concern among industry participants as to the volume of trades, and the increasing length of time that these trades remain unsettled. To date, industry efforts to alleviate problems arising from round robins have been unsuccessful in addressing the failed delivery issue. Finding a solution to the problem is made difficult due to complex processing procedures and large volumes of trades concentrated on specific settlement dates during the monthly settlement cycle. Manual efforts to resolve these occurrences are time-consuming and labor intensive. The complexity of tracking a round robin for numerous pools can take days, if not weeks to resolve. The tremendous growth in trading volume has substantially increased the amount of deliveries processed each month by industry participants.

An enormous problem in the MBS industry is that the fail confirmation process is currently conducted by individual financial organizations at the end of each month. The fail confirmation process is important as it ensures that firms verify and confirm their open fails. Open fails can potentially represent a trading risk if there is a significant movement in the market from the original trade date to the current date. Fail confirmation now occurs through a manual process in which, individual firms either phone, fax or email the contra side of trades in an effort to get a verbal or signed confirmation of the fail. This task is usually delegated to entry level clerks or temporary staff. By way of example, outstanding failed trades peaked in August of 2003, when there were approximately 1.5 trillion MBS failed trades outstanding.

The problem of outstanding fails in the MBS marketplace is thus a significant problem that is being scrutinized by the Federal Reserve Bank, US Treasury Department of Public Debt and the Securities Exchange Commission. Still others believe that fails of MBS trades is raising significant implications under the Sarbanes Oxley legislation which obliges principle executive and financial officers to certify the truth and completeness of financial statements and establish and maintain internal controls where a potential for risks exists. A non confirmed fail trade, as a potential market, credit, operational and capital risk, thus represents an important consideration for these officers.

In general, it is accepted that the US Securities regulatory regime's allowance of the short-selling of securities has the significant advantage of stimulating liquidity in the market. This is in sharp contrast to other jurisdictions, such as Europe, which, although moving closer to the US position, still do not allow such short-selling—and suffer from a lack of market liquidity. The problem, however, with allowing short-selling is that trades can and do fail, which is precisely the reason that such short-selling is not allowed in some jurisdictions. However, these other jurisdictions are moving closer to a short selling strategy to increase their market liquidity.

The Reconfirmation and Pricing Service (“RECAPS”) service offered by National Securities Clearing Corporation (“NSCC”) of New York provides a system for handling failed trades. RECAPS was released in August 1990 for the purpose of reentering Municipal and Corporate securities into the Continuous Net Settlement System (“CNS”) developed by NSCC. CNS nets trades between market participants to elevate the movement of securities during the settlement process. RECAPS was designed so that firms with outstanding fails for the time of the last RECAPS process could manually enter each failed trade into the RECAPS system in hopes that it would net. More specifically, on a quarterly basis (four times per year) individual firms trading Municipal or Corporate Securities on the New York Stock Exchange “(NYSE”) floor would reenter trades into RECAPS that were not entered into the CNS process on settlement date.

RECAPS has several limitations. RECAPS was designed for the operations of a limited number of specific stock exchanges. Each of those exchanges has its own specific means of operation. Thus RECAPS is useful for the processing of failed trades only for those particular exchanges. Further, the percentage of Municipal and Corporate Securities traded on the floor of such exchanges is almost insignificant in relation to the total volume of Municipal and Corporate Securities traded in the over the counter market. Thus, RECAPS is not capable of dealing with the vast majority of failed Municipal and Corporate trades. Moreover, RECAPS is a batch process that runs over a week period, and then produces reports thereafter.

In general, the process in RECAPS is performed quite infrequently (only about four times a year), and on a relatively small number of all trades, and takes a long period of time to execute. It is thus unsuitable and unusable as a comprehensive system to handle failed trades. Indeed, RECAPS main purpose is to re-net trades into the CNS, and not to specifically identify and confirm failed trades.

### SUMMARY OF THE INVENTION

It is an object of the present invention to provide a novel computer-based system and method for confirming failed trades of securities that obviates or mitigates at least one of the above-identified disadvantages of the prior art.

According to an aspect of the invention, there is provided a computer-based method for confirming failed trades comprising:
receiving data representing fail information from a plurality of traders, the fail information identifying a plurality of trades that failed to settle;
matching corresponding portions of the fail information between the traders;
generating a fail confirmation report reporting the corresponding portions to respective ones of the traders.

The method can further comprising the step of validating the fail information prior to performing the matching step. The validating step can comprises for each record in the fail information:
determining whether a format of the record is recognized;
rejecting the record if the format is not recognized;
determining, if the format is recognized, whether the record is standardized;
performing standardization operation on the record if the record is not recognized.

The standardization operation can be performed on a contra party identifier within the fail information, and the standardization operation can comprise the steps of:
accessing a plurality of pointers associated with the one of the trader's that originated the fail information;
locating the contra party identifier corresponding to one of the pointers;
substituting the contra party identifier with a standardized contra party identifier corresponding to the one of the pointers.

The matching step can comprise the steps of:
accessing a first set of the fail information respective to a first one of the traders;
accessing a first record within the first set;
accessing a second set of fail information respective to a second one of the traders;
searching the second set for a second record having trading characteristics substantially corresponding to the first record;
recording a failed trade between the second record to the first record.

The records can include a CUSIP; a contra party identifier; a net proceeds and a buy/sell indicator for a particular failed trade.

As part of the searching step, the records will be searched for identical CUSIPs, opposite contra party identifiers, substantially equal net proceeds and opposite buy/sell indicators.

The net proceeds can be within a predefined range in order to establish a match. The predefined range can, for example, be within twenty dollars of each other; or it can be within ten dollars of each other.

The can records include a CUSIP; a contra party identifier; at least one of a trade date and a settlement date, and a buy/sell indicator for a particular failed trade.

As part of the searching step, the records will be searched for identical CUSIPs, opposite contra party identifiers, substantially equal dates and opposite buy/sell indicators.

The aforementioned method and variants can be modified to repeat various steps for at least a portion of the remaining records in the fail information.

Another aspect of the invention provides a fail confirmation engine implemented in a computing environment including at least one processing unit, random access memory, a storage device and a network interface all interconnected by a bus. The processing unit is operable to execute an interface object for receiving fail information files from workstations connected to the network interface. The processing unit is operable to execute a matching object for examining the fail information files and matching fail trades within the fail information files. The matching object is further for generating fail-confirmations from the matched failed trades. The interface object for passing the fail confirmations to back to respective workstations.

The processing unit can be further operable to execute a preprocessing object for examining the received fail information; rejecting records in the received fail information that are not recognizable; and, if necessary, standardizing the received fail information where the received fail information is non-standardized. The preprocessing object can be operable to examine each record in the fail information and determines whether a format of the record is recognized; reject the record if the format is not recognized; determine, if the format is recognized, whether the record is standardized; perform a standardization operation on the record if the record is not recognized.

The standardization operation is performed on a contra party identifier within the fail information, the standardization operation comprises the steps of:
accessing a plurality of pointers associated with the one of the trader's that originated the fail information;
locating the contra party identifier corresponding to one of the pointers;
substituting the contra party identifier with a standardized contra party identifier corresponding to the one of the pointers.

The matching object is operable to access a first set of the fail information respective to a first one of the traders; access a first record within the first set; access a second set of fail information respective to a second one of the traders; search the second set for a second record having trading characteristics substantially corresponding to the first record; and record a failed trade between the second record to the first record.

The records can include a CUSIP; a contra party identifier; a net proceeds and a buy/sell indicator for a particular failed trade.

As part of the search, the records have identical CUSIPs, opposite contra party identifiers, substantially equal net proceeds and opposite buy/sell indicators.

### BRIEF DESCRIPTION OF THE DRAWINGS

The invention will now be described by way of example only, and with reference to the accompanying drawings, in which:

FIG. 1 is a schematic representation of a system for confirming failed trades in accordance with an embodiment of the invention;

FIG. 2 shows a flow-chart depicting a method for confirming failed trades in accordance with another embodiment of the invention;

FIG. 3 shows a flow-chart depicting a plurality of steps that can be used to perfoming one of the steps in the method depicted in FIG. 2;

FIG. 4 shows the system of FIG. 1 during the performance of one of the steps in the method of FIG. 3;

FIG. 5 shows the system of FIG. 1 during the performance of one of the steps in the method of FIG. 3;

FIG. 6 shows a flow-chart depicting a plurality of steps that can be used to perform one of the steps in the method depicted in FIG. 2;

FIG. 7 shows the system of FIG. 1 during the performance of one of the steps in the method of FIG. 6;

FIG. 8 shows the system of FIG. 1 during the performance of one of the steps in the method of FIG. 6;

FIG. 9 shows the system of FIG. 1 during the performance of one of the steps in the method of FIG. 6;

FIG. 10 shows the system of FIG. 1 after the performance of step 230 in FIG. 2;

FIG. 11 shows a flow-chart depicting a plurality of steps that can be used to perform one of the steps in the method depicted in FIG. 2;

FIG. 12 shows the system of FIG. 1 during the performance of one of the steps in the method of FIG. 11;

FIG. 13 shows the system of FIG. I during the performance of one of the steps in the method of FIG. 11;

FIG. 14 shows the system of FIG. 1 during the performance of one of the steps in the method of FIG. 11;

FIG. 15 is a schematic representation of a system for confirming round robin failed trades in accordance with an embodiment of the invention;

FIG. 16 is a flow chart depicting a method of confirming round robin failed trades in accordance with an embodiment of the invention; and,

FIG. 17 shows the system of FIG. 15 during the performance of one of the steps in the method of FIG. 16.

### DETAILED DESCRIPTION OF THE INVENTION

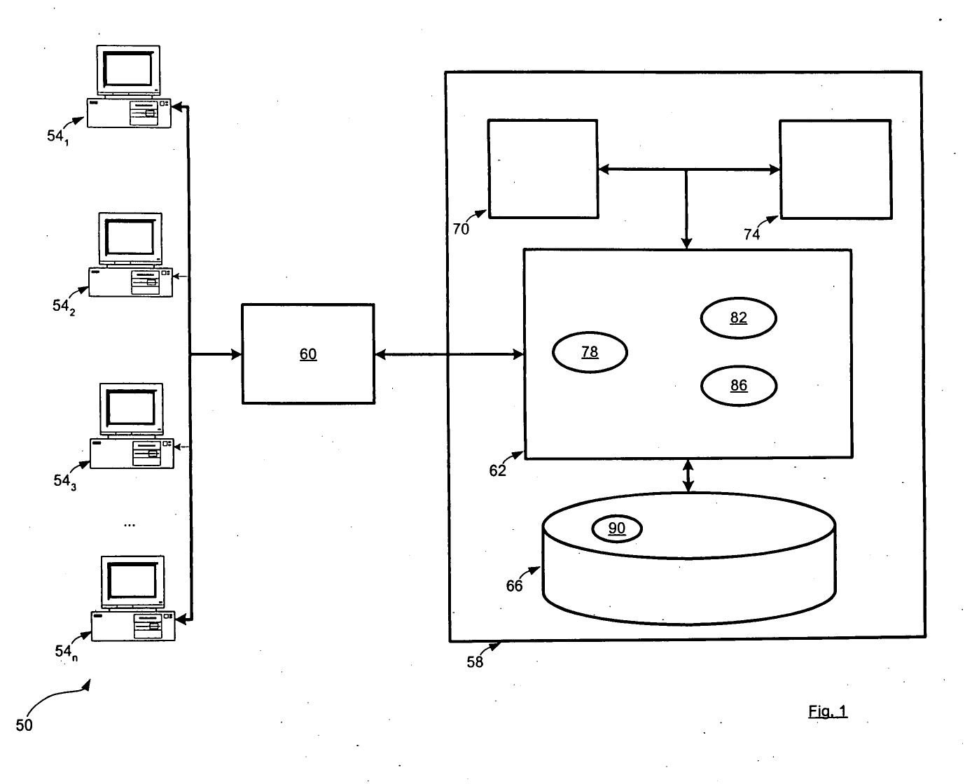

Referring now to FIG. 1, a system for confirming failed trades is indicated generally at 50. System 50 comprises a plurality of workstations 541, 542 54ₙ (generically referred to herein as “workstation 54” and collectively as “workstations 54”) all of which are connected to a fail-confirmation engine 58 via a network 60.

Each workstation 54 is typically a computing device such as a personal computer having a keyboard and mouse (or other input devices), a monitor (or other output device) and a desktop-module connecting the keyboard, mouse and monitor and housing one or more central processing units, volatile memory (i.e. random access memory), persistent memory (i.e. hard disk devices) and network interfaces to allow the workstation 54 to communicate over network 60. However, it is to be understood that workstation 54 can be any type of computing device, such as a personal digital assistant, cell phone, laptop computer, email paging device etc. Each workstation 54 is operated by a user (such as a trader or other professional) belonging to a firm. Moreover, each workstation 54 can be located in a different city, or on different floors of the same building belonging to a single firm. Each workstation 54 is used to provide fail information to engine 58 and receiving fail-confirmation information from engine 58 for presentation to the user respective to that workstation 54.

Network 60 can be wired or wireless, or based on combinations thereof, and based on any type of known network architecture or platform or combinations thereof. Communications network 60 is typically the Internet, but it can be any other type of medium used to interconnect workstations 54 to engine 58. For example, communications network 60 can be an intranet, a wide area network, a local area network or the like. Communications network 60 is operable to forward fail-confirmation information received from fail-confirmation engine 58 to workstations 54 for presentation to their respective users. Communications network 60 is also operable to forward fail information received from workstations 54 to a fail-confirmation engine 58 for further processing.

Fail-confirmation engine 58 is a server, a mainframe, or other type of computing environment. For example, fail-confirmation engine 58 can be a Sun 480R server from Sun Microsystems, Inc. of Palo Alto California, which has four central processing units (“CPUs”) and, because a significant portion of processing is performed in random access memory, such a server should be configured with about two to about five gigabytes (or more) of random access memory (“RAM”). Engine 58 can be run in a relational database through series of programming steps written as a stored procedure. The CPU, RAM and Hard Disk are all involved in running this procedure. However, it is to be emphasized that this particular server is merely exemplary, a vast array of other types of computing environments, (either presently known or still as yet unconceived,) for fail-confirmation engine 58 are within the scope of the invention.

Whichever computing environment is chosen, fail-confirmation engine 58 is operable to process fail information, determining matches of fail information between different trading firms, and sending fail-confirmations to workstations 54. Thus, within the chosen computing environment, fail-confirmation engine 58 typically includes at least one processor 62 and at least one storage device 66. Storage device 66 can be a hard disk drive, or a plurality thereof, or other type of non-volatile storage medium, and is operable to store fail information received from workstations 54. Processor 62 is generally operable to match that fail information, if possible. Typically, engine 58 also includes random access memory (“RAM”) 70 (or other type of volatile storage) coupled to processor 62 and which can be used by processor 62 in order to maintain a buffer of programming instructions and/or temporary data files to be accessed on a near-instantaneous basis as needed by processor 62. Typically, engine 58 also includes read only memory (“ROM”) 74 which maintains certain non-volatile programming instructions or the like which are used by processor 62 in order to fulfill the function of engine 58. The components within engine 58 are typically coupled together via a high speed bus. While not shown, engine 58 can include a plurality of other components as can be desired in order to provide desired functionality. For example, while not shown in FIG. 1, engine 58 typically includes a network interface intermediate between processor 62 and network 60. Engine 58 can also include user-input devices such as a mouse, keyboard to receive direct user-input; and/or user-output devices such as a monitor or printer to present user-output; and/or removable storage media. It should also be understood that the components providing the functionality of engine 58 need not be housed within a single computing device, but can be spread across a plurality of computing devices.

In a present embodiment, engine 58 is shown with a plurality of software processes and data files, represented as ovals 78, 82 and 86, in FIG. 1. (As used herein, any suitable programming language can be used to implement such processes and data files. For convenience, processes and data files and the like will be collectively referred to as software objects, though the use of the term ‘object’ should not be construed in a limiting sense, such as is attributable to software objects used in object oriented programming languages. Further, while engine 58 in a presently preferred embodiment is implemented using software objects, at least some of such software objects can be hard-coded into processor 62 and/or ROM 74 if desired.)

Processor 62 is represented in FIG. 1 as having an application interface object 78, a preprocessing object 82, and a matching object 86. Objects 78, 82 and 86 reside on storage device 66 or ROM 74, as desired, when engine 58 is “off”, but are loaded onto RAM 70, and execute on processor 62 when engine 58 is “on”. Interface object 78 manages the data input and output between engine 58 and workstations 54. Interface object 78 is operable to authenticate workstations 54 as they connect to engine 58, and, if validly authenticated, permit those workstations 54 to upload fail information from those workstations 54. Preprocessing object 82 is operable to examine the uploaded fail information, reject records in the uploaded fail information file that are not recognizable, and, if necessary, standardize the information in the information file. Matching object 86 is operable to examine the standardized information files received from various workstations and match fails between various information files. Matching object 86 is also operable to generate fail-confirmations from the matches, and then pass those fail confirmations to interface object 78 for redistribution back to respective workstations 54.

Storage device 66 is represented as storing a standardization database 90. Database 90 is accessible to preprocessing object 82 in order to standardize uploaded file information so that the standardized file information can be matched by matching object 86. Storage device 66 is also represented as storing an authentication credential data file 94 which contains security credentials associated with the trading firms that operate workstations 54. Such credentials are used to verify that trading firms accessing engine 58 via workstations 54 are authorized to do so. Further details about fail-confirmation engine 58 will be provided below.

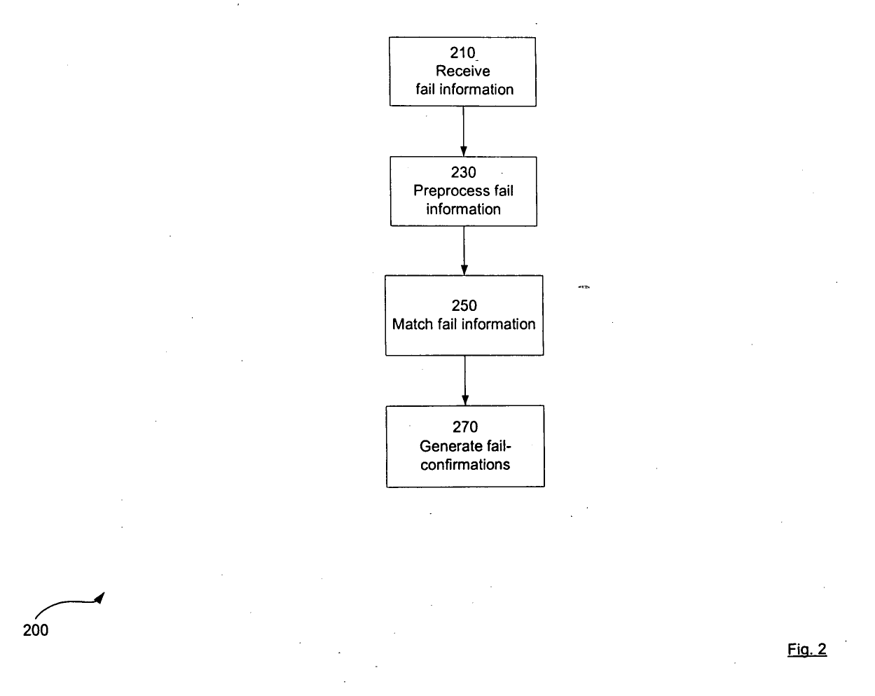

Referring now to FIG. 2, a method for confirming failed trades in accordance with another embodiment of the invention is indicated generally at 200. In order to assist in the explanation of the method, it will be assumed that method 200 is operated using system 50. Furthermore, the following discussion of method 200 will lead to further understanding of system 50 and its various components. However, it is to be understood that system 50 and/or method 200 can be varied, and need not work exactly as discussed herein in conjunction with each other, and that such variations are within the scope of the present invention.

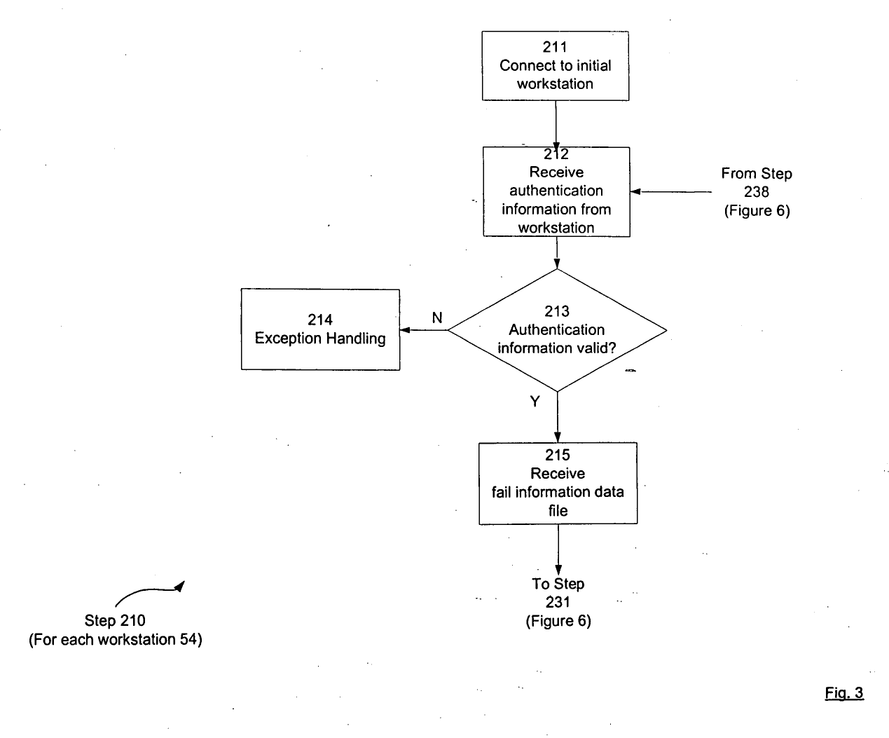

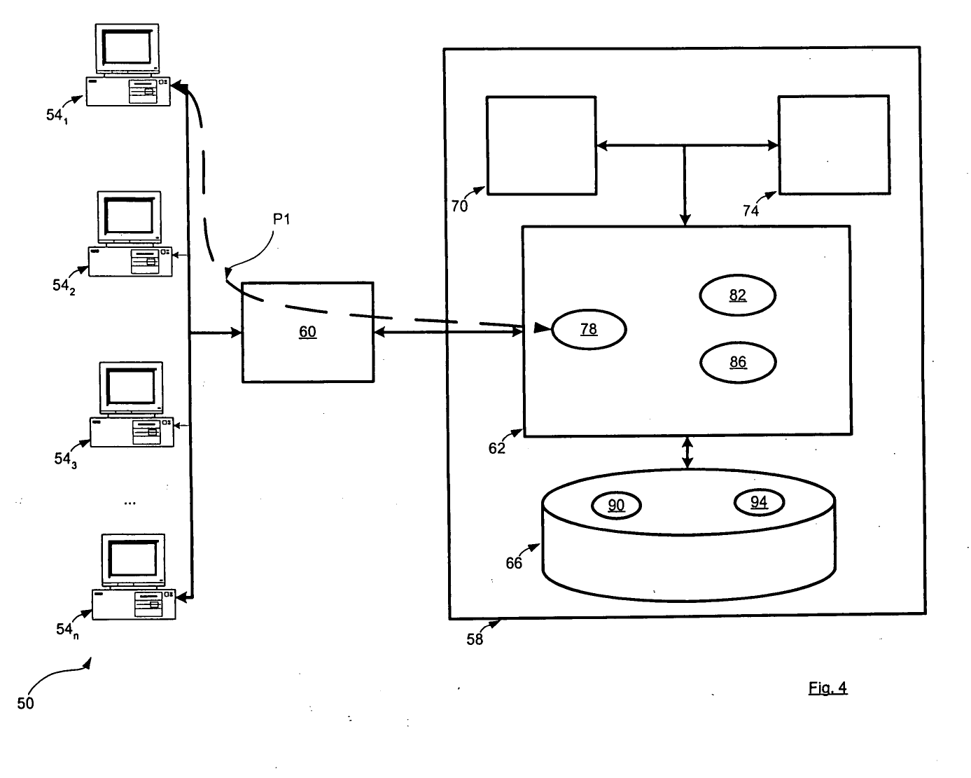

Beginning first at step 210, fail information is received. Step 210 can be performed by cooperative interaction between one or more workstations 54 and interface object 78. In one embodiment, step 210 is implemented using the sub-steps shown in FIG. 3. At step 211, a connection is made with an initial workstation. Such a connection is typically initiated by an operator of a particular workstation 54. As an example, it will be assumed that a user at workstation 54₁ accesses engine 58 via network 60 in the typical manner, such as by entering a web-site address identifying engine 58 or a proxy into a web-browser executing on workstation 54₁, which is eventually resolved to cause a web page to be presented on the display of workstation 54₁ by interface object 78. Such a connection can be made over a secure socket layer (“SSL”) or the like in order to provide an encrypted communication between engine 58 and workstation 54₁. The connection established at step 211 is represented by a virtual pathway indicated at reference P1 in FIG. 4.

Referring again to FIG. 3, at step 212, authentication information is received. Continuing with the example in FIG. 4, the web page presented on the display of workstation 54₁ presents a request for authentication information, such as authentication credentials, such as a user-id or other unique identifier and a password that is uniquely associated with that user-id. The user-id identifies that trading firm that is using engine 58; typically, though not necessarily, the trading firm associated with that user-id is the same trading firm that owns or operates workstation 54₁. It should be understood however, that any type of authentication information can be used at step 212, and need not be confined to a user-id/password combination.

At step 213, a determination is made if the authentication information received at step 212 valid. Step 213 is performed by object 78 which accesses authentication credential data file 94 stored on storage device 66. If the determination is ‘No’, the supplied authentication information is not valid, then the method advances to step 214 for exception handling. Exception handling at step 214 can be effected in any desired manner, such as allowing the reentry of information at step 212 a predefined number of times in the event that step 214 was reached due a typographical error entered at step 212. However, at a certain point, step 214 will typically cause method 200 to end and permit no further access to engine 58 from the workstation that failed to provide valid authentication information.

However, if at step 213 it is determined that ‘Yes’, the authentication information is valid, then the method advances to step 215, at which point a fail information data file is received. Step 215 can be effected by having the web page presented by interface object 78 allow the user at workstation 54₁ to identify a fail information data file stored on (or otherwise available) workstation 541, and then instruct that the identified fail information data file be uploaded to engine 78, and saved on storage device 66.

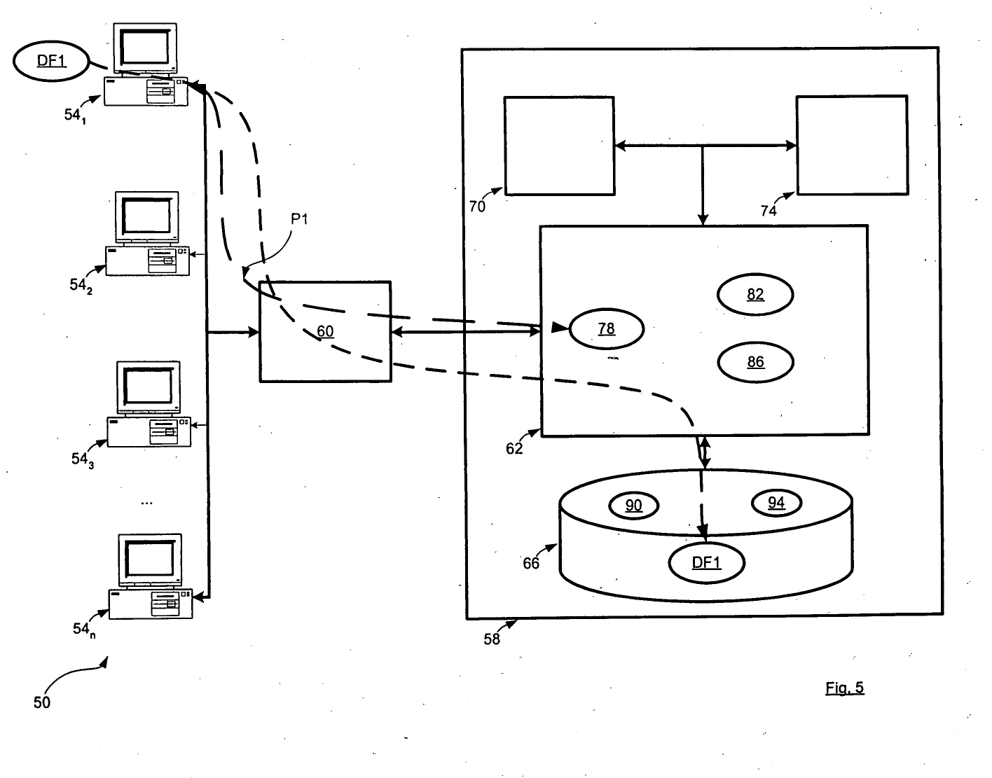

Data flow as at Step 215 is represented in FIG. 5, wherein a fail information data file indicated at DF1 is shown as being copied from workstation 54₁ to storage device 66 via virtual path P1 through interface object 78.

The format of data file DF1 is not particularly limited, but in a presently preferred embodiment data file DF1 is formatted such that data therein identifies failed trades of mortgage backed securities (“MBS”) belonging to the firm using workstation 54₁. An example format of file DF1 is shown in Table I.

TABLE I
Exemplary format of file DF1

FORMAT

| | | Suggested | |
|---|---|---|---|
| Field | Fields | Type and | Suggested |
| Number | Name | Length | Length |
| F1 | Sub Account | Alpha/Numeric | 20 |
| | Name or # | | |
| F2 | Cusip # | Alpha/Numeric | 9 |
| F3 | Buy/Sell | Alpha | 1 |
| F4 | Trade Date | Date | 8 |
| F5 | Settlement Date | Date | 8 |
| F6 | Par Value of | Numeric | 15 |
| | Trade | | |
| F7 | Trade Price | Numeric | 9 |
| F8 | Contra ID | Alpha/Numeric | 20 |
| F9 | Net Proceeds | Numeric | 15 |
| F10 | Transaction ID | Alpha/Numeric | 20 |

To explain Table I in greater detail, Field F1, entitled “Sub Account Name or #”, is typically about twenty alpha-numeric characters in length and is a unique identifier assigned to a sub account that identifies a particular account belonging to the firm that is using workstation 541. Field F2, entitled “CUSIP#”, is typically about nine numeric characters in length and is a unique identifier assigned to the security in question, as assigned by the Committee on Uniform Security Identification Procedures, (“CUSIP”) to develop a uniform method of identifying securities. Field F3, “Buy/Sell” is typically an alphabetic field of about one character in length, and is simply a flag to indicate a “B”, meaning “Buy” or “S” meaning Sell. The flag in Field F3 thus indicates whether there was an attempt to buy or sell the security in question. Field F4, “Trade Date” is a date field, of any suitable date format, such as “mm/dd/yy”. The trade date in Field F4 thus indicates the day that the trade of the security in question was actually made, even thought that trade eventually failed to settle. Field F5, “Settlement Date” is a date field, of any suitable date format, such as “mm/dd/yy”. The Settlement Date in Field F5 thus indicates the day that the security in question was actually to be actually settled.

Field F6, Par Value of Trade, is typically a numeric field of about fifteen characters in length and indicates the par value of the trade, or the amount of the trade attempted.

Field F7, “Trade Price” is typically a numeric field of about nine characters in length, and is the actual attempted trade price between the two parties involved in trading the security in question.

Field F8, “Contra ID”, is typically an alphanumeric field of about twenty characters in length, and is a unique identifier that identifies the other firm involved in the trading attempt. (As used herein, the term “contra” refers to the name of the firm on the opposite side of a particular trade of a particular security.) Field F9 “Net Proceeds” is typically a numeric field of about fifteen characters in length and reflects the total net proceeds that were to be have been exchanged on the settlement date indicated in Field F5.

Field F10, “Transaction ID” is typically an alphanumeric field of about twenty characters in length, and reflects a unique identifier that identifies the transaction for the particular security in question.

It is to be reiterated that the format shown in Table I is merely exemplary, and that the various names, lengths, types and actual quantities of the fields can vary. Greater or fewer fields can be used as desired. For example, Field F7 is optional in that fail confirmations can be effected without the information contained in this field. By the same token Field F10 can also be made completely optional, in that it can be automatically generated by engine 58 rather than being supplied by the user of workstation 54₁. Those of skill in the art should now recognize that other aspects of Table I can also be varied.

Table II shows exemplary contents of data file DF1.

TABLE II
Exemplary contents of file DF1

| | | | F3 | | | | | | | |
|---|---|---|---|---|---|---|---|---|---|---|
| | F1 | | Buy | | | | F7 | F8 | | F10 |
| | Sub | F2 | vs | F4 | F5 | F6 | Trade | Contra | F9 | Transaction |
| Record | Account | Cusip | Sell | Trade Date | Settlement Date | Par Value | Price | ID | Net Proceeds | ID |
| 1 | Smith 1 | 31391VRW5 | b | Jul. 15, 2004 | 17/08/2004 | 1651200 | 100.125 | 542 | 1653264 | AA100 |
| 2 | Smith 1 | 31368HLN1 | s | Jul. 16, 2004 | Aug. 13, 2004 | 1010000 | 99.08375 | 542 | 1000745.88 | AA101 |
| 3 | Smith 1 | 31368HLT8 | b | Jul. 17, 2004 | Aug. 14, 2004 | 467719 | 102.0313 | 543 | 477219.66 | AA102 |
| 4 | Smith 2 | 31368HL35 | s | Jul. 18, 2004 | Aug. 15, 2004 | 120438 | 98.25 | 543 | 118330.34 | AA103 |
| 5 | Smith 2 | 31371KUA7 | b | Jul. 19, 2004 | Aug. 16, 2004 | 1010000 | 99.0875 | 54n | 1000783.75 | AA104 |
| 6 | Jones 1 | 31371KU33 | s | Jul. 20, 2004 | Aug. 17, 2004 | 1010000 | 100.0078 | 54n | 1010078.91 | AA105 |
| 7 | Jones 1 | 31391QRM8 | b | Jul. 21, 2004 | Aug. 18, 2004 | 451843 | 100.125 | 54n | 452407.8 | AA106 |
| 8 | Jones 1 | 31403CUT6 | s | Jul. 22, 2004 | Aug. 19, 2004 | 943000 | 99.08375 | 54n | 934359.76 | AA107 |
| 9 | Jones 1 | 31402T2H7 | X | Jul. 23, 2004 | Aug. 20, 2004 | 511000 | 102.0313 | 54n | 521379.82 | AA108 |

The contents of Table II will be used further in the discussion herein to assist in describing various features and aspects of the present invention, but it is to be reiterated that such contents are purely exemplary.

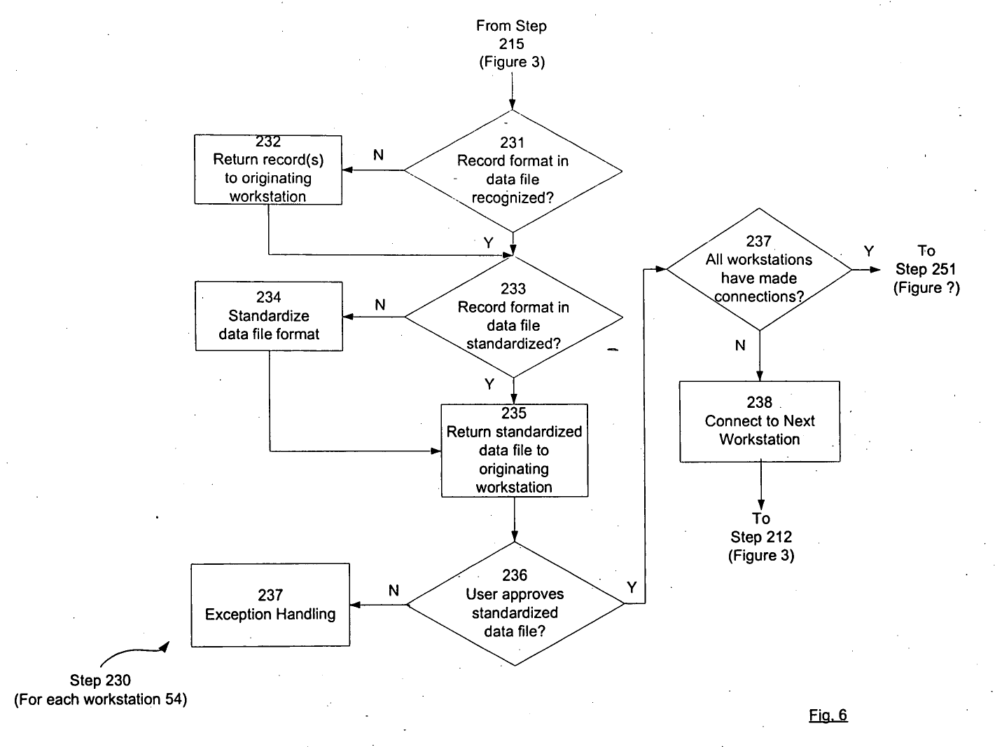

Having completed step 215, and thereby completed step 210, then referring again to FIG. 2, method 200 advances from step 210 to step 230 at which point the fail information received at step 210 is preprocessed. When implemented on system 50, step 230 is performed by preprocessing object 82. In an embodiment, step 230 is implemented using the sub-steps shown in FIG. 6, as performed by preprocessing object 82. Beginning at step 231, a determination is made as to whether the record format in the received data file is recognized. At step 231, preprocessing object will thus access data file DF1 on storage device. 66 and examine its contents. During such examination, preprocessing object 82 will compare the actual contents of data file DF1 (i.e. the contents of Table II) to determine whether those contents strictly conform with an expected format (i.e. the format described in Table I), or, if those contents do not strictly conform, whether any such variation is something that is at least recognizable so that the contents could be made to conform with the expected format.

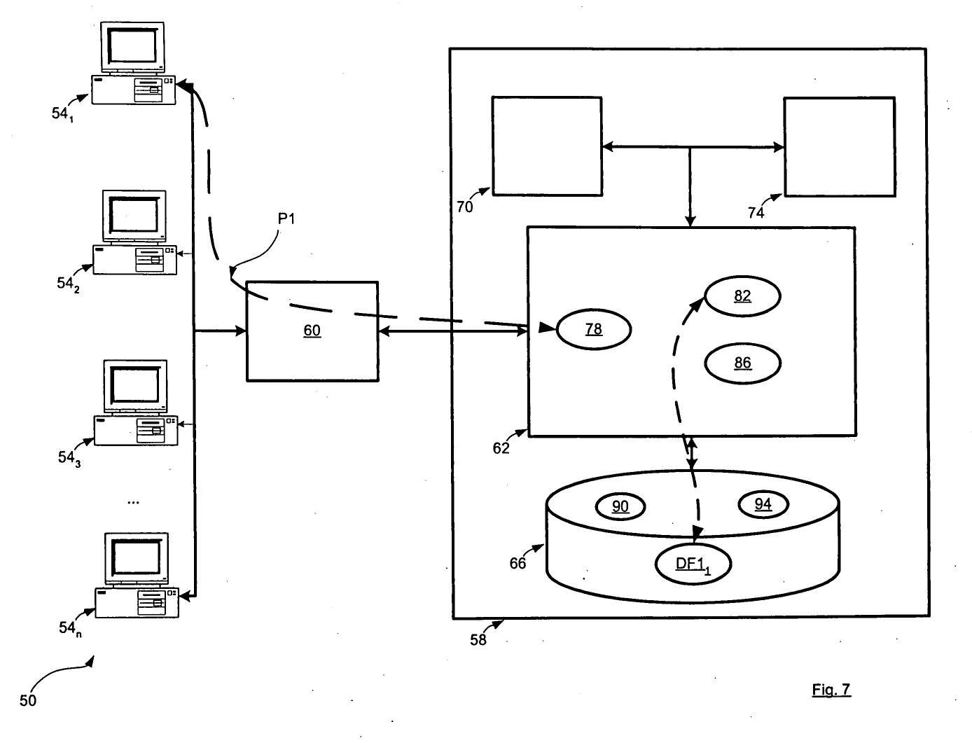

Continuing with the present example, at step 231, an examination of data file DF1 shows that the contents of record 9 in Field F3 of data file DF1 contains value “X”. Since, according to Table I, the expected contents of Field F3 is either “B” or “S”, then at step 231 then record 9 containing the value “X” in Field F3 would be deemed unrecognizable by preprocessing object 82, and the method would advance from step 231 to step 232, and record 9 would be returned to the originating workstation, which in this case is workstation 54₁. By the same token, data file DF1 would be updated, to delete record 9 therefrom, and a new data file DF1₁ would be generated by preprocessing object 82 and saved in storage 66, as represented in FIG. 7. Table III shows the new contents 10 of data file DF1₁.

TABLE III
Exemplary contents of file DF1₁ after performance of step 232 on data file DF1

| | | | F3 | | | | | | | |
|---|---|---|---|---|---|---|---|---|---|---|
| | F1 | | Buy | | | | F7 | | F9 | F10 |
| | Sub | F2 | vs | F4 | F5 | F6 | Trade | F8 | Net | Transaction |
| Record | Account | Cusip | Sell | Trade Date | Settlement Date | Par Value | Price | Contra ID | Proceeds | ID |
| 1 | Smith 1 | 31391VRW5 | b | Jul. 15, 2004 | 17/08/2004 | 1651200 | 100.125 | 542 | 1653264 | AA100 |
| 2 | Smith 1 | 31368HLN1 | s | Jul. 16, 2004 | Aug. 13, 2004 | 1010000 | 99.08375 | 542 | 1000745.88 | AA101 |
| 3 | Smith 1 | 31368HLT8 | b | Jul. 17, 2004 | Aug. 14, 2004 | 467719 | 102.0313 | 543 | 477219.66 | AA102 |
| 4 | Smith 2 | 31368HL35 | s | Jul. 18, 2004 | Aug. 15, 2004 | 120438 | 98.25 | 543 | 118330.34 | AA103 |
| 5 | Smith 2 | 31371KUA7 | b | Jul. 19, 2004 | Aug. 16, 2004 | 1010000 | 99.0875 | 54n | 1000783.75 | AA104 |
| 6 | Jones 1 | 31371KU33 | s | Jul. 20, 2004 | Aug. 17, 2004 | 1010000 | 100.0078 | 54n | 1010078.91 | AA105 |
| 7 | Jones 1 | 31391QRM8 | b | Jul. 21, 2004 | Aug. 18, 2004 | 451843 | 100.125 | 54n | 452407.8 | AA106 |
| 8 | Jones 1 | 31403CUT6 | s | Jul. 22, 2004 | Aug. 19, 2004 | 943000 | 99.08375 | 54n | 934359.76 | AA107 |

(Of course, if, in our example, all records in data file DF1 had been recognizable to preprocessing object 82 at step 231, then the method would proceed to step 233 directly from step 231 without any modification to data file DF1.) While not shown in FIG. 6, if ALL records were unrecognizable then method 200 could simply end. It should now also be understood that any number of ways of populating data file DF1 can result non-recognizable records in relation to the format described in Table I and cause their rejection at step 231. An exemplary list of such ways includes, but is not limited to: a) the CUSIP Number is invalid and does not conform with any known CUSIP Number; b) One or more duplicate copies of the same record were found; c) the Settlement Date is prior to the Trade Date; d) The Net Proceeds do not reflect the Par Value and the Trade Price e) The contra ID is invalid and is not found in engine 58.

The next step in the method is step 233 (whether arrived at directly from step 231 or via step 232). At step 233, a determination is made as to whether the record format in the data file is standardized. Continuing with our example, preprocessing object 82 will then examine data file DF1₁ to ascertain if any records are not in a standardized format that is strictly in accordance with the format defined in Table I.

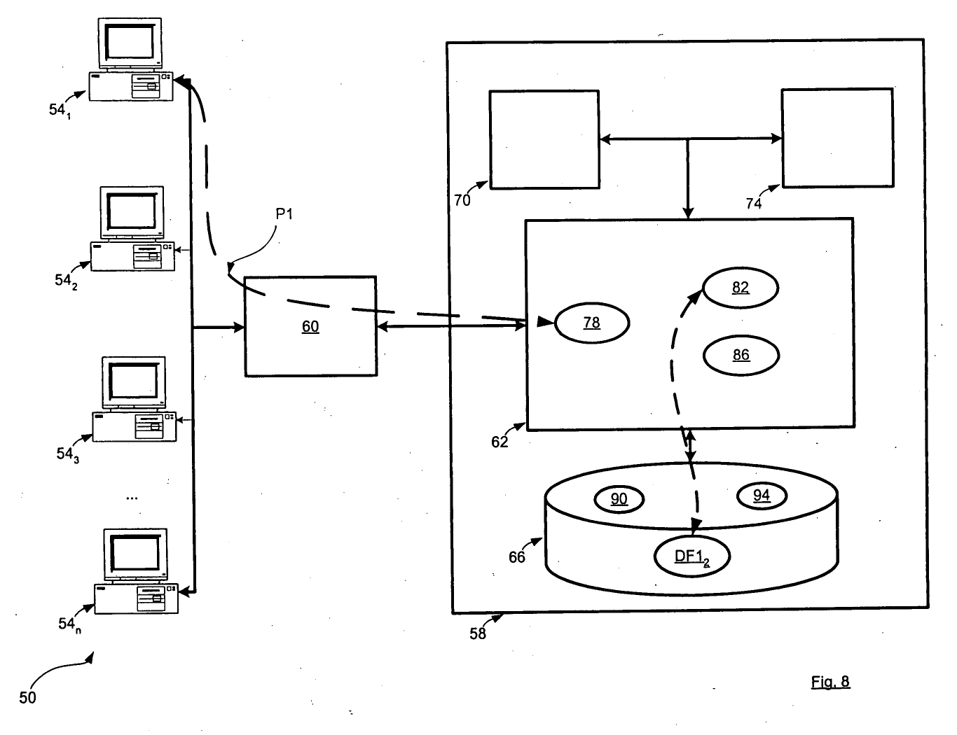

Continuing with the present example, at step 233, an examination of data file DF1 shows that the contents of record 1 in Field F5 of data file DF1 contains value “Aug. 17, 2004”. This is recognizable as a date at step 231, however, according to Table I, the expected date format of Field F5 is “mm/dd/yy”. Thus, at step 233 record 1 containing the value “Aug. 17, 2004” in Field F5 would be deemed non-standardized by preprocessing object 82, and the method would advance from step 233 to step 234, and record 1 would be automatically updated to place record 1 in standard form. By the same token, data file DF1₁ would be updated with the new, standardized version of record 1, and a new data file DF1₂ would be generated by preprocessing object 82 and saved in storage 66, as represented in FIG. 8. Table IV shows the new contents of data file DF1₂, whereby record 1 in Field F5 of data file DF1 now contains value “Aug. 17, 2004”.

TABLE IV
Exemplary contents of file DF1₂ after performance of step 234 on data file DF1₁

| | F1 | | F3 | | F5 | | | F8 | | F10 |
|---|---|---|---|---|---|---|---|---|---|---|
| | Sub | F2 | Buy vs | F4 | Settlement | F6 | F7 | Contra | F9 | Transaction |
| Record | Account | Cusip | Sell | Trade Date | Date | Par Value | Trade Price | ID | Net Proceeds | ID |
| 1 | Smith 1 | 31391VRW5 | b | Jul. 15, 2004 | Aug. 17, 2004 | 1651200 | 100.125 | 542 | 1653264 | AA100 |
| 2 | Smith 1 | 31368HLN1 | s | Jul. 16, 2004 | Aug. 13, 2004 | 1010000 | 99.08375 | 542 | 1000745.88 | AA101 |
| 3 | Smith 1 | 31368HLT8 | b | Jul. 17, 2004 | Aug. 14, 2004 | 467719 | 102.0313 | 543 | 477219.66 | AA102 |
| 4 | Smith 2 | 31368HL35 | s | Jul. 18, 2004 | Aug. 15, 2004 | 120438 | 98.25 | 543 | 118330.34 | AA103 |
| 5 | Smith 2 | 31371KUA7 | b | Jul. 19, 2004 | Aug. 16, 2004 | 1010000 | 99.0875 | 54n | 1000783.75 | AA104 |
| 6 | Jones 1 | 31371KU33 | s | Jul. 20, 2004 | Aug. 17, 2004 | 1010000 | 100.0078 | 54n | 1010078.91 | AA105 |
| 7 | Jones 1 | 31391QRM8 | b | Jul. 21, 2004 | Aug. 18, 2004 | 451843 | 100.125 | 54n | 452407.8 | AA106 |
| 8 | Jones 1 | 31403CUT6 | s | Jul. 22, 2004 | Aug. 19, 2004 | 943000 | 99.08375 | 54n | 934359.76 | AA107 |

Of course, if more than one record was non-standardized then all of those records would be standardized at step 234.

It should now also be understood that any number of ways of populating data file DF1 can result in the creation of non-standardized records in relation to the format described in Table I and be detected as such as step 233, but which can be automatically converted into a standardized format at step 234. Of particular note, Field F8 contains an identity of the other trading firm associated with the failed trade. In many circumstances, different traders may use different codes to identify different trading firms (or different trading floors of firms), yet it is presently preferred that all such codes be standardized upon processing of a data file DF at step 234. Standardization database 90 can thus be populated with a table that identifies the trader codes used by different trading firms, and matches them with a standardized code. Table V shows an example of such a standardization database 90.

TABLE V
Exemplary contents of database 90

| | Column | | | | |
|---|---|---|---|---|---|
| | 1 | 2 | 3 | 4 | 5 |
| | Trader | Trader | Trader | Trader | Standard |
| Row | 541 | 542 | 543 | 54n | Code |
| 1 | 541 | A | E | I | 541 |
| 2 | 542 | B | F | J | 542 |
| 3 | 543 | C | G | K | 543 |
| 4 | 54n | D | H | L | 54n |

Explaining Table V in greater detail, Column 5 shows all of the standard codes that are used by engine 58 to identify different traders as used by all of the traders operating workstations 54, assuming that a different trader operates each respective workstation 54. Specifically, Trader 541 refers to the trader operating workstation 54₁; Trader 542 refers to the trader operating workstation 54₂; Trader 543 refers to the trader operating workstation 54₃; and, Trader 54n refers to the trader operating workstation 54ₙ. Thus, Column 1 shows all of the codes employed by Trader 541 to identify all of the traders in system 50; Column 2 shows all of the codes employed by Trader 542 to identify all of the traders in system 50; Column 3 shows all of the codes employed by Trader 543 to identify all of the traders in system 50; Column 4 shows all of the codes employed by Trader 54n to identify all of the traders in system 50; Column 5 shows all of the standardized codes employed engine 58 to identify all of the traders in system 50. Continuing with our previous example, an examination of Table V shows that Trader 541 uses the same codes as engine 58 and thus data in Field 8 of DF1 need not changed in order to standardize those codes. However, data files supplied by other traders would be expected to include non-standardized codes, and thus at step 234 such non-standardized codes are standardized by preprocessing object 82. For example, Trader 542 would use the code “A” to identify Trader 541 in its uploaded data files DF. Thus, such codes would be updated in data files DF uploaded by trader 542 to substitute “541” in place of “A” by preprocessing object 82.

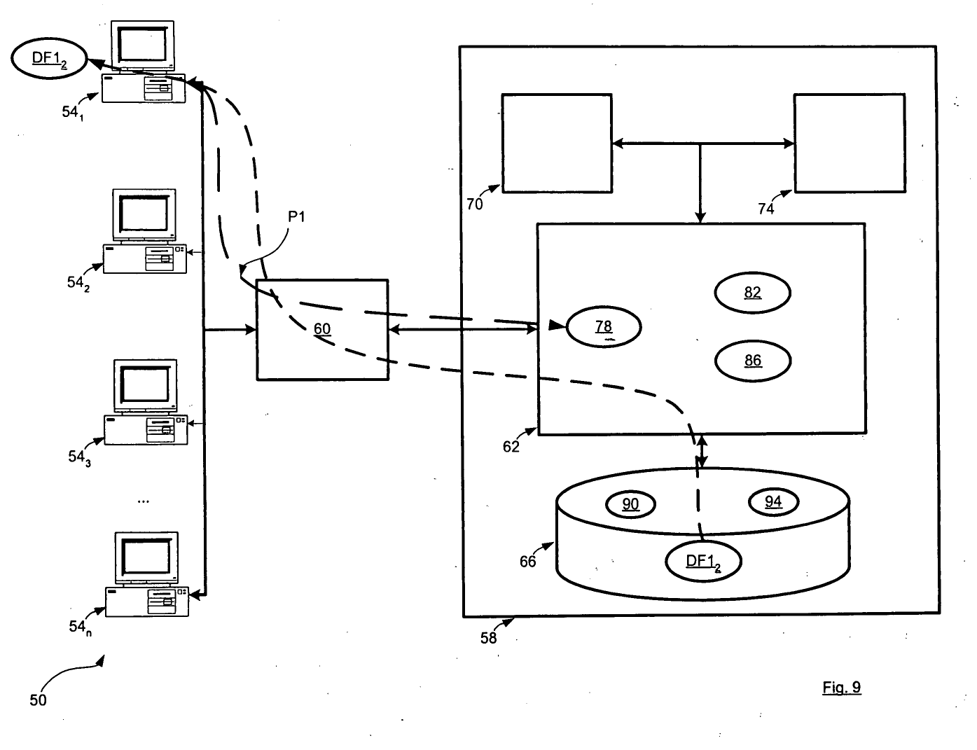

Referring again to FIG. 6, the next step in the method is step 235 (whether arrived at directly from step 233 or via step 234). At step 235, the standardized data file is returned to the originating workstation. Continuing with the example involving data file DF1₂ of Table IV, this step is represented in FIG. 9, as data file DF1₂ is returned to workstation 54₁ via interface object 78. This step can be performed any number of ways, such as directly through a web interface or via an email or any other desired means. Having done so, the method advances to step 236 at which point a determination is made as to whether the user at the relevant workstation approves the standardized data file. In the present example, the user operating workstation 54₁ will thus review the contents of data file DF1₂ and the user will provide a response to interface object 78 to indicate approval or disapproval of the new version of data file DF1₂.

If, at step 236, the user does not approve data file DF1₂, then the method advances to step 237 for exception handling. Such exception handling could simply require that the user begin anew from step 212 or from step 215 to resubmit a new data file DF with the view to correct whatever deficiencies were discovered by the user at step 236. Alternatively, at step 237 the user could be given the opportunity, directly at step 237, to amend data file DF1₂ and have that amended data file be resubmitted automatically at step 215 so that steps 231-236 can be performed again on the amended data file.

Referring again to FIG. 6, once the user does approve the contents of the data file at step 236, then contents of database DF1₂ are flagged as being complete and stored on storage device 66 for subsequent processing. Additionally, the method advances to step 238 at which point a determination is made as to whether connections with all workstations have been made.

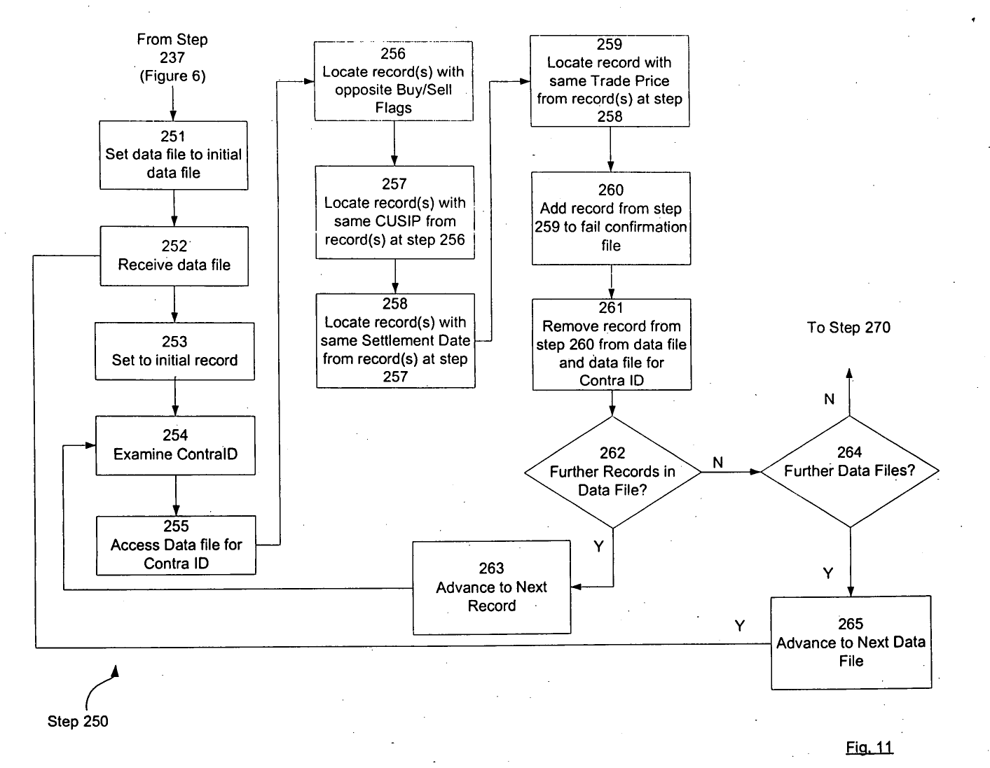

If the determination at step 238 is “Yes”, then step 230 of method 200 is now complete and method 200 can advance to step 250. In the present embodiment step 250 is implemented on system 50, step 250 is performed by matching object 86. In an embodiment, step 250 is implemented using the sub-steps shown in FIG. 11, as performed by matching object 86. Step 250 and its sub-steps in FIG. 11 will be discussed in greater detail below.

If, however, at step 238 it is determined that “No”, connections with all workstations have not been made, then the method advances to step 239 and a new connection is made with a remaining one of the workstations 54 in system 50. Steps 210 and 230 are thus repeated, in substantially the fashion described above, for all workstations 54 in system 50 (i.e. all of those workstations 54 that wish to participate in the fail-confirmation process). Thus, steps 210 and 230 are performed, using the sub-steps shown in FIGS. 3 and 6, respectively, for workstation 54₂, workstation 54₃, and workstation 54ₙ.

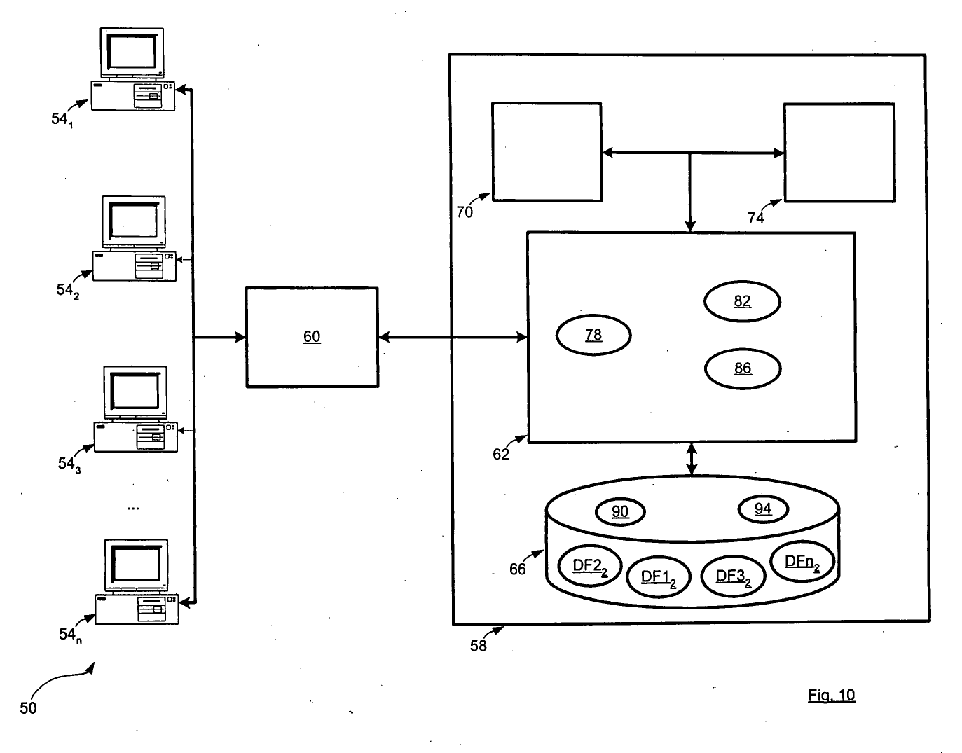

Thus, once steps 210 and 230 are complete for all workstations 54, then a data file DF respective to each workstation 54 will be maintained on storage 66. The completion of the performance of steps 210 and 230 for all workstations 54 is represented in FIG. 10, where data file DF1₂ is associated with trader 541 and workstation 54₁; data file DF2₂ is associated with trader 542 and workstation 54₂; data file DF3₂ is associated with trader 543 and workstation 54₃; and data file DFn₁ is associated with trader 54n and workstation 54ₙ.

Thus, once system 50 reaches the state shown in FIG. 10, then, referring now to FIG. 4, a determination will be made at step 237 that “Yes” a connection has been made with all workstations and the method will advance to step 251 in FIG. 11.

Before discussing step 250 in FIG. 11, it will be assumed that the contents of data file DF1₂ are the same as those shown in Table IV. It will also be assumed that at least part of the contents of data file DF2₂ are shown in Table VI, below.

TABLE VI
Exemplary partial contents of file DF2₂

| | F1 | | F3 | F4 | F5 | F6 | F7 | F8 | F9 | F10 |
|---|---|---|---|---|---|---|---|---|---|---|
| | Sub | F2 | Buy vs | Trade | Settlement | Par | Trade | Contra | Net | Transaction |
| Record | Account | Cusip | Sell | Date | Date | Value | Price | ID | Proceeds | ID |
| 1 | Hill 1 | 31368HLN1 | b | Jul. 16, 2004 | Aug. 13, 2004 | 1010000 | 99.08375 | 541 | 1000745.88 | AA101 |
| 2 | Hill 2 | 31391VRW5 | s | Jul. 15, 2004 | Aug. 17, 2004 | 1651200 | 100.125 | 541 | 1653264 | AA100 |

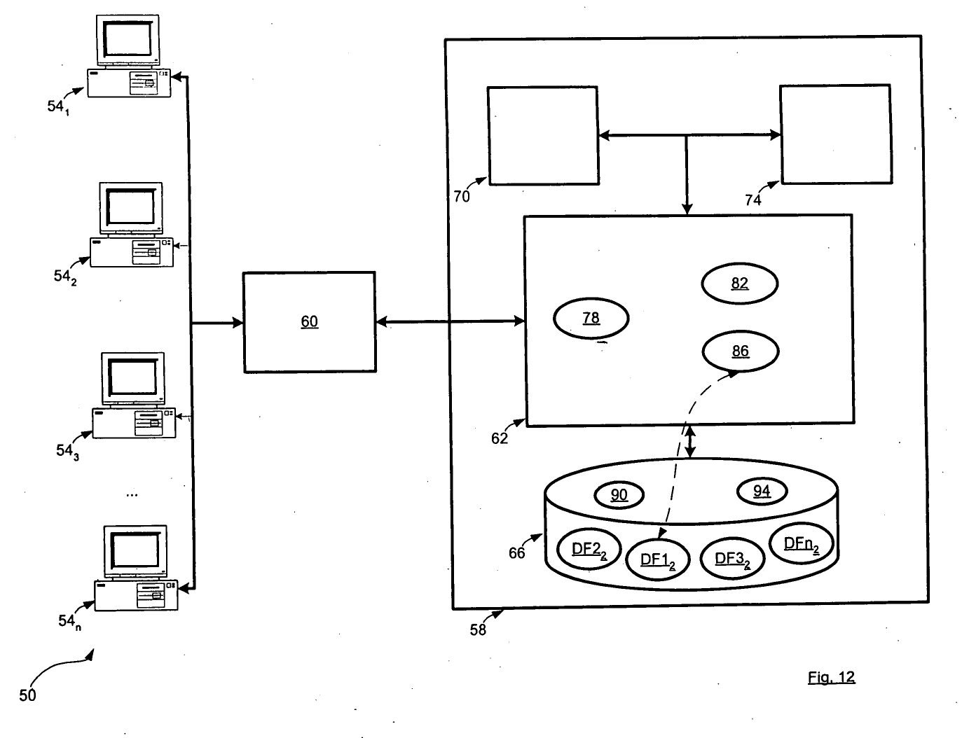

Referring now to FIG. 11, beginning first at step 251, a data file pointer is set to an initial data file. Continuing with the present example, it will be assumed that the initial data file will be data file DF1₂. Next, at step 252, that initial data file is received. Step 252 is represented in FIG. 12, as matching object 86 and data file data file DF1₂ are shown with a dotted line therebetween, representing matching object 86 accessing data file DF1₂. Next, at step 253, a record pointer for that data file DF is set to an initial record within that data file DF. Continuing with the present example, it is assumed that the record pointer is set to Record 1 of data file DF1₂.

Next, at step 254, the ContraID of the first or a next data record is examined. Continuing with the present example, then matching object 86 of will examine Field F8, “ContraID” of Record 1 of data file DF1₂ to reveal a ContraID of “542”, as shown in Table IV.

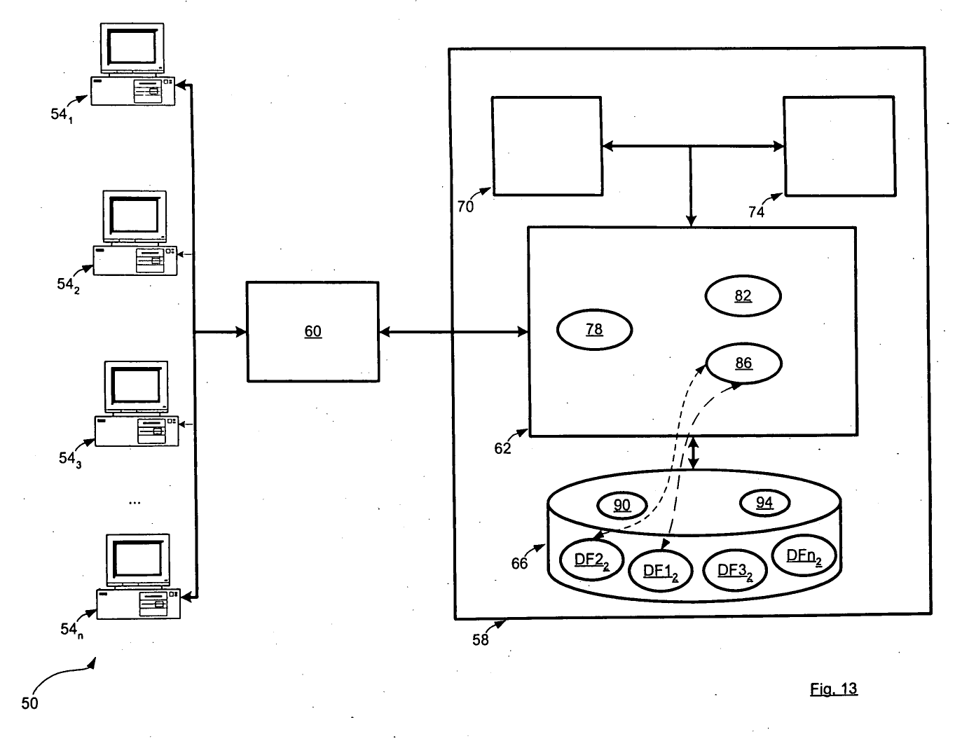

Having located a ContraID of 542, matching object 86 can then determine that it must examine the data file DF corresponding to trader 542 in order to locate a match for the failed trade identified in Record 1 of data file DF1₂. Thus, at step 255, matching object 86 will access of data file DF2₂ (i.e. as shown in Table VI), and as represented in FIG. 13.

Next, at step 256, matching object 86 will locate records with opposite buy/sell flags. More specifically, matching object 86 of will examine Field F3, “Buy/Sell” of Record I of data file DF1₂ to reveal a “b”, indicating Buy code; and will then accordingly look for a “s” or Sell code in Field F3, “Buy/Sell” of all of the records of data file DF2₂ as shown in Table VI, and will thus determine that Record 2 of data file DF2₂ contains a “s”. (Where data file DF2₂ contained more than one record with a Sell code, as would be typical, then all of those records would be identified. Thus, the locating of only one record according to this example is a simplification for purposes of facilitating explanation). (Note that, in certain situations not specifically described herein, it is possible that multiple records might have identical characteristics, in which the transaction ID would be used to differentiate them. A duplicate transaction ID would be viewed as a duplicate record.) (Table VII shows a temporary table created by matching object 86 upon the performance of step 256, with Field F3 highlighted to show the match).

TABLE VII
Records from data file DF2₂ located at step 256

| | F1 | | F3 | F4 | F5 | F6 | F7 | F8 | F9 | F10 |
|---|---|---|---|---|---|---|---|---|---|---|
| | Sub | F2 | Buy vs | Trade | Settlement | Par | Trade | Contra | Net | Transaction |
| Record | Account | Cusip | Sell | Date | Date | Value | Price | ID | Proceeds | ID |
| 2 | Hill 2 | 31391VRW5 | s | Jul. 15, 2004 | Aug. 17, 2004 | 1651200 | 100.125 | 541 | 1653264 | AA100 |

Having located Record 2 of data file DF2₂, the method advances to step 257 at which point records having the same CUSIP are located from within the. group of records located at step 256. More specifically, matching object 86 of will examine Field F2, “CUSIP” of Record 1 of data file DF1₂ to reveal the CUSIP number “31391VRW5”; and will then accordingly look for the same CUSIP “in Field F2, “CUSIP” of the records of data file DF2₂ as shown in Table VII, and will thus determine that Record 2 of data file DF2₂ contains CUSIP number “31391VRW5”. (Again, where data file DF2₂ contained more than one record with a matching CUSIP numbers, as would be typical, then all such records would be identified within Table VII. Again, the locating of only one record according to this example is a simplification for purposes of facilitating explanation).

Table VIII shows a temporary table created by matching object 86 upon the performance of step 257, with Field F2 to highlighted to show the match.

TABLE VIII
Records from data file DF2₂ located at step 257

| | F1 | | F3 | F4 | F5 | F6 | F7 | F8 | F9 | F10 |
|---|---|---|---|---|---|---|---|---|---|---|
| | Sub | F2 | Buy vs | Trade | Settlement | Par | Trade | Contra | Net | Transaction |
| Record | Account | Cusip | Sell | Date | Date | Value | Price | ID | Proceeds | ID |
| 2 | Hill 2 | 31391VRW5 | s | Jul. 15, 2004 | Aug. 17, 2004 | 1651200 | 100.125 | 541 | 1653264 | AA100 |

The method then advances to step 258, at which point records having the same Settlement Date are located from within the group of records located at step 257. (Note that while in the present embodiment, records with the “same” Settlement Date are located, in other embodiments Settlement Dates of substantially the same value could be located—for example, records where Settlement Dates are less than or equal to about three days of each other, or less than or equal to about two days of each other, or more preferably less than or equal to about one day of each other.) More specifically, matching object 86 of will examine Field F5, “Settlement Date” of Record 1 of data file DF1₂ to reveal the Settlement Date “Aug. 17, 2004”; and will then accordingly look for the same Settlement Date in Field F5; of the records of data file DF2₂ as shown in Table VIII, and will thus determine that Record 2 of data file DF2₂ also contains the Settlement Date “Aug. 17, 2004”. (Again, where data file DF2₂ contained more than one record with matching Settlement Dates, as would be typical, then all of those records would be identified within Table VIII. Again, the locating of only one record according to this example is a simplification for purposes of facilitating explanation).

Table IX shows a temporary table created by matching object 86 upon the performance of step 258, with Field F5 to highlighted to show the match.

TABLE IX
Records from data file DF2₂ located at step 258

| | F1 | | F3 | F4 | F5 | F6 | F7 | F8 | F9 | F10 |
|---|---|---|---|---|---|---|---|---|---|---|
| | Sub | F2 | Buy vs | Trade | Settlement | Par | Trade | Contra | Net | Transaction |
| Record | Account | Cusip | Sell | Date | Date | Value | Price | ID | Proceeds | ID |
| 2 | Hill 2 | 31391VRW5 | s | Jul. 15, 2004 | Aug. 17, 2004 | 1651200 | 100.125 | 541 | 1653264 | AA100 |

The method then advances to step 259, at which point records having the same Net Proceeds are located from within the group of records located at step 258. (Note that while in the present embodiment, records with the “same” net proceeds are located, in other embodiments net proceeds of substantially the same value could be located—for example, records where net proceeds are less than or equal to about $50 of each other, or less than or equal to about $20 of each other, or, more preferably less than or equal to about $10 of each other.)

More specifically, matching object 86 will examine Field F9, “Net Proceeds” of Record 1 of data file DF1₂ to reveal the Net Proceeds of 1653264; and will then accordingly look for the same Net Proceeds in Field F9; of the records of data file DF2₂ as shown in Table IX, and will thus determine that Record 2 of data file DF2₂ also contains the Net Proceeds of 1653264. (Again, where data file DF2₂ contained more than one record with matching Settlement Dates, as would be typical, then all of those records would be identified within Table IX. Again, the locating of only one record according to this example is a simplification for purposes of facilitating explanation).

Table X shows a temporary table created by matching object 86 upon the performance of step 258, with Field F9 to highlighted to show the match.

TABLE X
Records from data file DF2₂ located at step 259

| | F1 | | F3 | F4 | F5 | F6 | F7 | F8 | F9 | F10 |
|---|---|---|---|---|---|---|---|---|---|---|
| | Sub | F2 | Buy vs | Trade | Settlement | Par | Trade | Contra | Net | Transaction |
| Record | Account | Cusip | Sell | Date | Date | Value | Price | ID | Proceeds | ID |
| 2 | Hill 2 | 31391VRW5 | s | Jul. 15, 2004 | Aug. 17, 2004 | 1651200 | 100.125 | 541 | 1653264 | AA100 |

As a result of performing steps 256-259, matching object 86 typically arrives at one match once step 259 is complete, although multiple records may be identified at steps 256-258 depending on the volume of trading activity between the traders associated with the data files DF at issue. The result of steps 256-259 should thus produce a table such as Table X, with only one record. While not shown in FIG. 11, if more than one record was returned at step 259, or no records were returned at step 260, then an exception handling step would be generated—reporting this anomaly to one or both of trader 541 and trader 542.

Thus, the method then advances to step 260, at which point the record identified at step 259 is added to a fail confirmation file. Table XI shows an exemplary format of such a fail confirmation file.

TABLE XI
Exemplary Fail Confirmation File Generated at Step 260

| | | F2 | | F3 | | | | |
|---|---|---|---|---|---|---|---|---|
| | F1 | FTD Trader | F2 | FTR Trader | | F5 | F6 | F7 |
| | Trader | Record | Trader | Record | F4 | Settlement | Trade | Trans- |
| Record | FTD | Number | FTR | Number | Cusip | Date | Price | action ID |
| 1 | 542 | 2 | 541 | 1 | 31391VRW5 | Aug. 17, 2004 | 100.125 | AA100 |

To explain Table XI in greater detail, the column “Record” is a unique number for each record located at step 259 as the method cycles through all records in all data files DF, and such records are appended to Table XI. In the example shown in Table XI, only one record has been added as this reflects the first pass through the method. Field F1, “Contra Firm Trader FTD” identifies the name of the trader that failed-to-deliver (“FTD”). In the example discussed above, since trader 542 was supposed to “sell” to trader 541, then trader 542 is the trader that failed-to-deliver, and thus Field 1 of Record 1 of Table XI indicates trader “542”. Field F2, “FTD Trader Record Number” identifies the record in the data file DF belonging to the trader identified in Field 1. In the example discussed above, Record 2 of data file DF2₂ showed the relevant failed trade, and thus Field 2 of Record 1 of Table XI indicates “2”.

Field F3, “Trader FTR” identifies the name of the trader that failed-to-receive (“FTR”). In the example discussed above, since trader 541 was supposed to “buy” from trader 542, then trader 541 is the trader that failed-to-receive, and thus Field 3 of Record 1 of Table XI indicates trader “541”. Field F4, “FTR Trader Record Number” identifies the record in the data file DF belonging to the trader identified in the corresponding record of Field 3. In the example discussed above, Record 1 of data file DF1₂ showed the relevant failed trade, and thus Field F4 of Record 1 of Table XI indicates “1”.

Likewise, Field F4 “CUSIP”, Field F5 “Settlement Date”, Field F6 “Trade Price” and Field F7 “Transaction Number” all correspond to the same values in the corresponding matched records from data files DF1₂ and DF2₂.

It is to be reemphasized that the format of Table XI is exemplary. In general, the fail confirmation file generated at step 260 includes a single record that identifies all pertinent aspects of a given fail between two traders such that a message generated from such that a report can be sent to each of those two traders from that record that allows those two traders to take steps to correct the fail. Further details about such a report will be discussed in greater detail below.

Next, at step 261, the records identified data files DF from step 260 are removed (or at least “flagged” as having been matched and therefore withdrawn from further analysis) from their respective data files DF. Continuing with the present example, Record I is removed from data file DF1₂; and Record 2 is withdrawn from data file DF2₂, so that those records are not further analyzed during subsequent cycles of the steps shown in FIG. 11.

Next, at step 262, a determination is made as to whether there are additional records in the data file received at step 251. If “Yes”, then the method advances to step 263, and the data file is advanced to the next record. In the example discussed above, then at this point data file DF1₂ in Table IV is advanced from Record 1 to Record 2, and then the method returns to step 254, at which point steps 254-262 are repeated and thereby continue to populate the fail confirmation file at step 260 for all records in data file DF1₂.

Once, however, at step 262 it is determined that there are no more records in data file DF1₂ to be analyzed, then the method advances to step 264 and a determination is made as to whether there are any more data files to be analyzed. In the present example, once the records in data file DF1₂ have been analyzed, then the method advances to step 265 at which point the data file is advanced to the next data file DF, in this example, to data file DF2₂. The method then returns from step 265 to step 252, at which point steps 253-264 are repeated for all records in data file DF2₂, to look for equivalent failed trades in data file DF3₂ and data file DFn₂. (Those of skill in the art will recognize that, in an ideal scenario, and provided there are no exceptions and matches are available for all data files DF, it may not even be needed to perform step 250 on data files DFn₂ as records therein will already have been matched.)

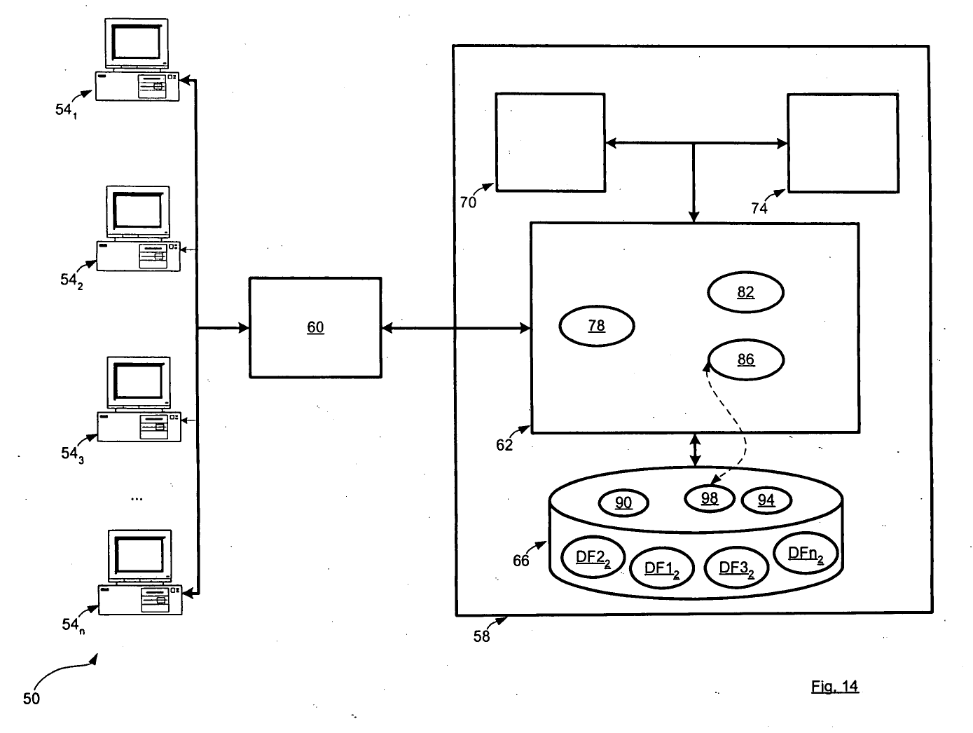

The end result of performing step 250, as shown in FIG. 11, for all records in all data files DF will be to have prepared a complete fail confirmation file that builds on the fail confirmation file shown in Table XI. The complete fail confirmation file is represented in FIG. 14 as fail confirmation file 98 saved in storage 66.

Referring again to FIG. 2, after performing step 250, method 200 will then advance to step 270 at which point fail confirmations will be generated for each firm. Such fail confirmations can be generated from fail confirmation file 98, as a specific report is tailored for each workstation 54 such that the traders associated with those workstations 54 can begin the process of fulfilling deliveries that previously failed, and/or accepting any deliveries where they failed to receive, and/or taking any steps to handle penalties associated with such failures (i.e. interest charges, or payments to satisfy breaches.)

Those of skill in the art will recognize that the foregoing specific example represents a highly-simplified multi-party fail, (i.e. a chain of failed trades that occur when a series of failed trades can be traced between a group of firms all attempting, but failing, to trade in the same security.) In more complex and typical examples, trades of the same CUSIP may fail in a sequence, for example, trader 541 fails to deliver to trader 543; trader 543 fails to deliver to trader 54n; trader 54n fails to deliver to trader 542; etc. Confirmation of these, and other types of multi-part fails are within the scope of the invention.

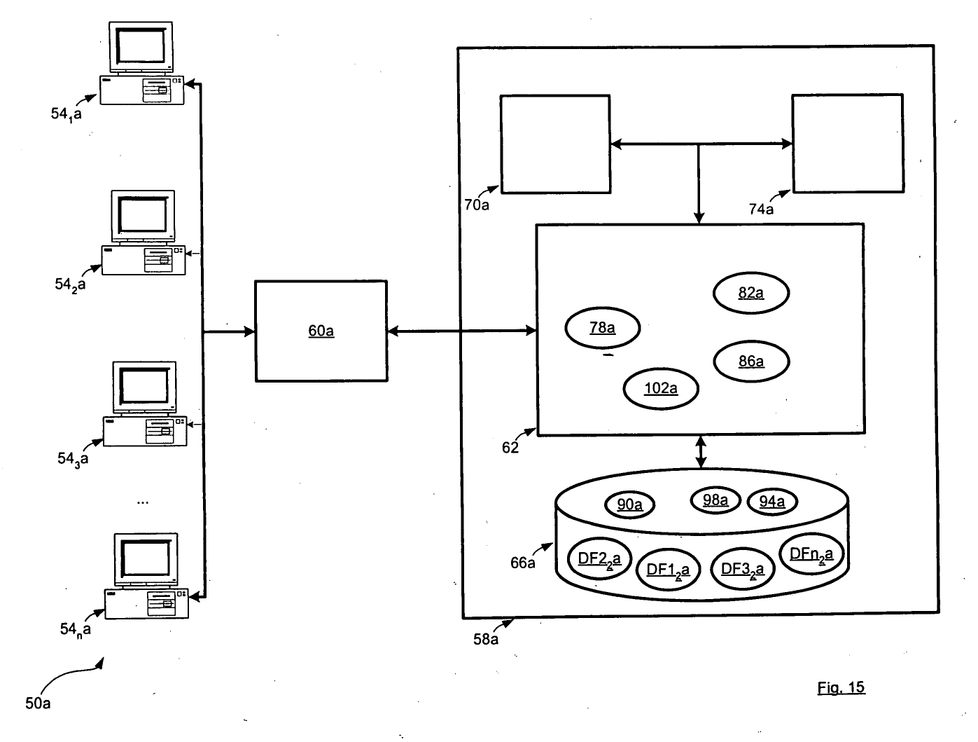

Another embodiment is a system and method for confirming round-robin failed trades. A system in accordance with this embodiment is indicated at 50a in FIG. 15. System 50a is substantially the same as system 50, and like reference components have like reference characters, except followed by the suffix “a”. Of note, however, system 50a also includes a round-robin detection object 102a, which is operable to examine fail confirmation file 98a to detect the existence of any round robin fail scenarios.

As known to those of skill in the art, a round robin occurs when a complete loop can be traced between a group of firms all attempting, but failing, to trade in the same security. An example of a round robin scenario is as follows:

Assume that a mortgage backed security having the CUSIP# 31371K2Z3 and having a Trade Amount of one million bonds and having a settlement date of Aug. 17, 2004 is traded, prior to the settlement date, and that those trades failed to settle as on Aug. 17, 2004, according to the following:
a) Trader 541 buys at $102 from Trader 54n
b) Trader 541 sells at $100 to Trader 542
c) Trader 542 buys at $100 from Trader 541
d) Trader 542 sells at $100 ½ to Trader 543
e) Trader 543 buys at $100 ½ from Trader 542
f) Trader 543 sells at $101 to Trader 54n
g) Trader 54n buys at $101 from Trader 543
h) Trader 54n sells at $102 to Trader 541

Upon performing method 200 using system 50a based on data files DF that are submitted by each trader to include the above exemplary round robin scenario, then the Fail Confirmation File 98a generated at step 260 will include records of the form shown in Table XII.

TABLE XII
Exemplary Fail Confirmation File 98a Generated at Step 260 including
A Round Robin of Failed Trades

| | | F2 | | F3 | | | |
|---|---|---|---|---|---|---|---|
| | F1 | FTD Trader | | FTR Trader | | F5 | |
| | Trader | Record | F2 | Record | F4 | Settlement | F6 |
| Record | FTD | Number | Trader FTR | Number | Cusip | Date | Trade Price |
| 1 | 54n | 111 | 541 | 222 | 31371K2Z3 | Aug. 17, 2004 | 102 |
| 2 | 541 | 333 | 542 | 444 | 31371K2Z3 | Aug. 17, 2004 | 100 |
| 3 | 542 | 555 | 543 | 666 | 31371K2Z3 | Aug. 17, 2004 | 100.1 |
| 4 | 543 | 777 | 54n | 888 | 31371K2Z3 | Aug. 17, 2004 | 101.5 |

Of note, Table XII is of substantially the same format as Table XI, except that Field F7 is omitted for convenience. Further, the record numbers are purely exemplary. Also of note, it would be typical for file 98a to include several hundred or several thousands, or more, of additional records—and the four records need not actually appear in order within the additional records. Thus, the four records above are shown for convenience and simplicity in order to explain the present embodiment. As will be discussed in further detail below, an analysis of file 98a will reveal the existence of the round robin in Records 1-4.

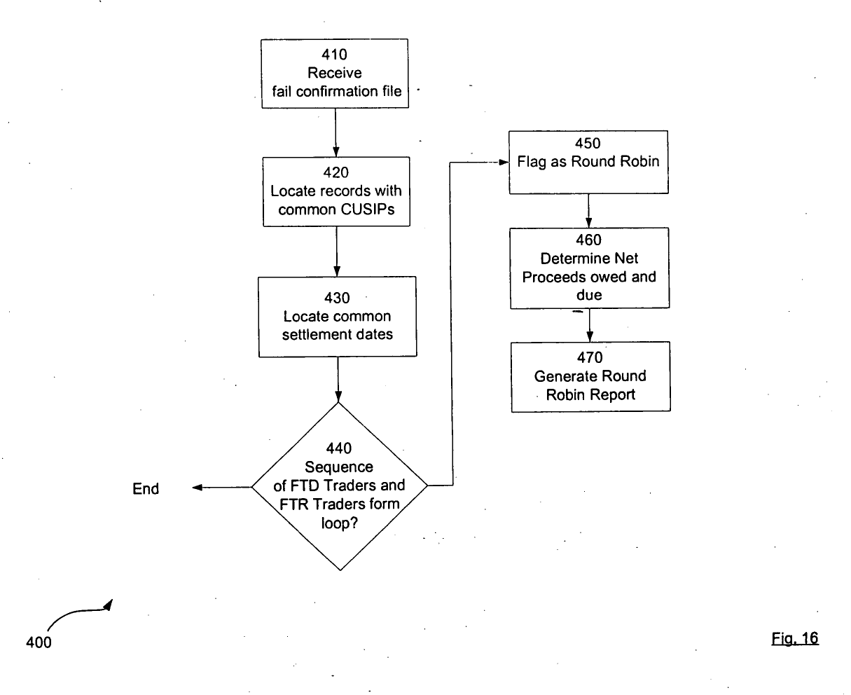

FIG. 16 shows a flow chart depicting a method for confirming round-robin failed trades indicated generally at 400. Method 400 provides a sequence of steps that can be implemented with round-robin detection object 102a, or some other functionally equivalent hardware and/or software computing environment.

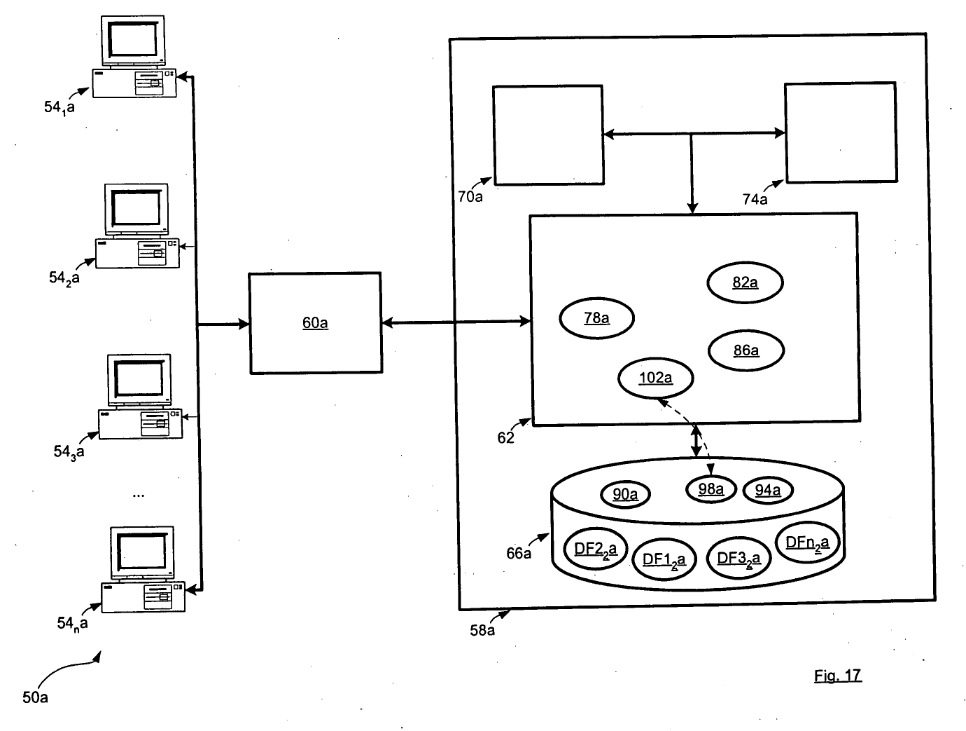

Assuming method 400 is implemented on system 50a on object 102a, then beginning at step 410, the fail confirmation file is received. As represented in FIG. 17 Object 102a will thus access file 98a (i.e. the contents of Table XII). Next, at step 420, records with common CUSIPs are located. Likewise, at step 430, records with common Settlement Dates are located. Thus, file 98a will be analyzed and Records 1-4 of Table XII will be identified as meeting the criteria searched for in steps 420 and 430.

Next, at step 440, a determination is made as to whether the sequence of fail-to-deliver traders and fail-to-receive traders within those records found at steps 420 and 430 has a loop consistent with a round-robin. Thus, an analysis of Fields F1 and F3 of Records 1-4 of Table XII show a loop of a trade starting at Trader 54n, then to Trader 541, and then to Trader 542, and then to Trader 543, and finally looping back to Trader 54n. Accordingly, in this example, it would be determined at step 440 that a sequence existed thereby confirming the existence of a round robin. Thus, method 400 would advance from step 440 to step 450. (On the other hand, if no such sequence was found, then method 400 would “end” after step 440, or begin a new on another batch of records within file 98a).

Thus, at step 450, the records located at step 430 would be flagged as being part of a round robin. Then, at step 460, a determination would be made as to the net proceeds that would be owed and due for each Trader. For example, in this example, trader 541 would owe $20,000 having bought one million bonds at $102 and sold, at a loss, at $100. By the same token, trader 54n is owed $10,000, (from trader 541) having bought at $101 and sold at $102. By the same token, trader 543 is owed $5,000, (from trader 541) having bought at $100 ½ and sold at $101. By the same token, trader 542 is owed $5,000, (from trader 541) having bought at $100 and sold at $100 ½. Finally, at step 470, a round robin report would be generated identifying the round robin and reporting it to the traders involved, and the net proceeds owed to that particular trader. Table XIII shows an example of how such a report may look, based on the round robin in Table XII.

TABLE XIII
Exemplary Round Robin Report Generated at Step 470

| | | F2 | | F3 | | | | | |
|---|---|---|---|---|---|---|---|---|---|
| | F1 | FTD Trader | F2 | FTR Trader | | F5 | F6 | Round | Trader Amount = 1 |
| | Trader | Record | Trader | Record | F4 | Settlement | Trade | Robin | Million |
| Record | FTD | Number | FTR | Number | Cusip | Date | Price | Identifier | Net proceeds |
| 1 | 54n | 111 | 541 | 222 | 31371K2Z3 | Aug. 17, 2004 | 102 | 1 | $10,000 owed from |
| | | | | | | | | | Trader 541 |
| 2 | 541 | 333 | 542 | 444 | 31371K2Z3 | Aug. 17, 2004 | 100 | 1 | -$20,000, owing. $10,000 |
| | | | | | | | | | to Trader 54n; $5,000 to |
| | | | | | | | | | trader 542; $5,000,000 to |
| | | | | | | | | | trader 543; |
| 3 | 542 | 555 | 543 | 666 | 31371K2Z3 | Aug. 17, 2004 | 100½ | 1 | $5,000 owed from |
| | | | | | | | | | Trader 541 |
| 4 | 543 | 777 | 54n | 888 | 31371K2Z3 | Aug. 17, 2004 | 101 | 1 | $5,000 owed from |
| | | | | | | | | | Trader 541 |

Explaining Table XIII in greater detail, Table XIII includes substantially the same information as Table XII (i.e. the contents of file 98a), and thus includes the same fields, but includes two additional fields. (Thus, the round robin report generated at step 470 can be effected simply by updating file 98a to identify the round robins therein.) More specifically, a “Round Robin Identifier” Field is added, which flags these four Records as being the first complete round robin identified within file 98a. (In that where file 98a includes more records, then more round robins may be found during subsequent cycles of method 400.) Additionally, a “Net Proceeds” field is added, which identifies the amounts that each Trader owes to other Trader(s), or the amounts that each Trader is owed from others, in order to rectify the failed trades resulting from the round robin.

Thus, the contents of Table XIII (or appropriate portions thereof) can thus be reported back to each respective workstation 54 associated with the round robin in order to confirm the round robin and identify the consequences thereof.

Also of note, various steps or sub-steps of the methods described herein can stand-alone as unique embodiments in and of themselves. For example, step 230, and its variants, can be used to preprocess information received for other mortgage backed security applications. For example, those teachings of step 230, (and other teachings herein) may be combined with the teachings for pooling of mortgage backed securities found in the Applicant's co-pending application, U.S. patent application Ser. No. 10/735,749, filed Dec. 16, 2003, the contents of which are incorporated herein by reference.

While specific combinations of the various features and components of the present invention have been discussed herein, it will be apparent to those of skill in the art that desired subsets of the disclosed features and components and/or alternative combinations of these features and components can be utilized, as desired. For example, it should now be understood that the file 98, 98a, and/or the round robin report from method 400 can be used to generated sophisticated reports for each trader. Once the contents of those files 98, 98a or the round robin report are received by the trader complex filtering, sorting and other manipulation of data therein can be effected to help each trader work efficiently to take steps to resolution the failed trades and/or round robins therein. Further, such files 98, 98a and/or the round robin report can be integrated with back end computing systems local to each trader, so that resolution of the failed trades and/or round robins can be effected automatically. Such automatic resolution can include a) actually delivering the security that was not originally delivered and/or b) automatically wiring a fee in satisfaction of obligations arising from the failure to effect delivery and/or c) generating a report for financial auditing purposes in order to verify that such failed trades are being resolved and/or d) locating a security of substantially the same value to be substituted for the security that failed to trade and/or combinations of any of the foregoing.

An additional feature that can be added to the reports generated by system 50, is exposure reporting. As the failed trade remains outstanding, the value of the trade increases or decreases, and so if there is a counter party insolvency, then exposure is increased. Thus, an exposure report can be readily generated from the other reports generated using the teachings herein.

In another variation, repurchase agreements can be administered using aspects of the fail management system and method described herein. Using the system, an automated interface can be provided to administer such repurchase agreements.

An advantage of the present invention is that system 50 can be a central interface for a large asset manager such as Pacific Management Investment Company, who has to interface with hundreds of custodial banks. System 50, using the preprocessing technique described herein, can be part of providing a common interface to the large asset manager for those custodial banks. Thus, such an asset manager can streamline its operations by having system 50 serve as a common gateway for those custodial banks. In turn, a fee can be charged to the asset manager for the gateway service.

It is to be reiterated that the specific means of implementing method 200, and/or the sequence of the steps therein, can be modified, and/or performed in different sequences and/in parallel, and is otherwise not particularly limited as will now occur to those of skill in the art. As another example, in FIG. 11, in steps 254-259 the contraID, buy/sell flags, CUSIP numbers, Settlement Dates, and Net Proceeds fields are examined in order to find match fail information. However, these steps need not be performed in this sequence, and/or other fields could be used. For example, CUSIP; contraID; net and proceeds and buy/sell indicator could be used. Optionally, settlement date and/or trade date could be used.

Also, while the foregoing has been described in relation to confirming failed trades in mortgage backed securities, likewise, fail confirmations could be effected for other securities, including government bonds, corporate bonds, municipal bonds, international bonds, equities, derivatives, commodities and/or foreign exchange.

The above-described embodiments of the invention are intended to be examples of the present invention and alterations and modifications may be effected thereto, by those of skill in the art, without departing from the scope of the invention which is defined solely by the claims appended hereto.

1. A computer-based method for confirming failed trades comprising:
receiving data representing fail information from a plurality of traders, said fail information identifying a plurality of trades that failed to settle;
matching corresponding portions of said fail information between said traders;
generating a fail confirmation report reporting said corresponding portions to respective ones of said traders.

2. The method of claim 1 further comprising the step of validating said fail information prior to performing said matching step.

3. The method of claim 2 wherein said validating step comprises, for each record in said fail information:
determining whether a format of said record is recognized;
rejecting said record if said format is not recognized;
determining, if said format is recognized, whether said record is standardized;
performing standardization operation on said record if said record is not recognized.

4. The method of claim 3 wherein said standardization operation is performed on a contra party identifier within said fail information, said standardization operation comprises the steps of:
accessing a plurality of pointers associated with the one of said trader's that originated said fail information;
locating said contra party identifier corresponding to one of said pointers;
substituting said contra party identifier with a standardized contra party identifier corresponding to said one of said pointers.

5. The method of claim 1 wherein said matching step comprises the steps of:
accessing a first set of said fail information respective to a first one of said traders;
accessing a first record within said first set;
accessing a second set of fail information respective to a second one of said traders;
searching said second set for a second record having trading characteristics substantially corresponding to said first record;
recording a failed trade between said second record to said first record.

6. The method of claim 5 wherein said records include a CUSIP; a contra party identifier; a net proceeds and a buy/sell indicator for a particular failed trade.

7. The method of claim 6 wherein, as part of said searching step, said records have identical CUSIPs, opposite contra party identifiers, substantially equal net proceeds and opposite buy/sell indicators.

8. The method of claim 7 wherein said net proceeds are within twenty dollars of each other.

9. The method of claim 5 wherein said records include a CUSIP; a contra party identifier; at least one of a trade date and a settlement date, and a buy/sell indicator for a particular failed trade.

10. The method of claim 9 wherein, as part of said searching step, said records have identical CUSIPs, opposite contra party identifiers, substantially equal dates and opposite buy/sell indicators.

11. The method of claim 5 comprising the additional steps of:
removing said first and said second records from said sets of fail information;
repeating said foregoing steps for at least a portion of remaining records in said fail information.

12. A fail confirmation engine implemented in a computing environment including at least one processing unit, random access memory, a storage device and a network interface all interconnected; said at least one processing unit operable to receive fail information from workstations connected to said network interface; said at least one processing unit operable to examine said fail information and match failed trades between said fail information files; said at least one processing unit further operable to generate fail-confirmations from said matched failed trades and for passing said fail confirmations to back to respective workstations.

13. The engine of claim 12 wherein said processing unit is operable to execute an interface object for receiving said fail information and for passing said fail confirmations back to said workstations; said processing unit further operable to execute a matching object to examine said fail information and match said failed trades.

14. The engine of claim 13 wherein said processing unit is further operable to execute a preprocessing object for examining said received fail information; rejecting records in said received fail information that are not recognizable; and, if necessary, standardizing said received fail information where said received fail information is non-standardized.

15. The engine of claim 14 wherein said preprocessing object is operable to examine each record in said fail information and determines whether a format of said record is recognized; reject said record if said format is not recognized; determine, if said format is recognized, whether said record is standardized; perform a standardization operation on said record if said record is not recognized.

16. The engine of claim 15 wherein said standardization operation is performed on a contra party identifier within said fail information, said standardization operation comprises the steps of:
accessing a plurality of pointers associated with the one of said trader's that originated said fail information;
locating said contra party identifier corresponding to one of said pointers;
substituting said contra party identifier with a standardized contra party identifier corresponding to said one of said pointers.

17. The engine of claim 13 wherein said matching object is operable to access a first set of said fail information respective to a first one of said traders; access a first record within said first set; access a second set of fail information respective to a second one of said traders; search said second set for a second record having trading characteristics substantially corresponding to said first record; and record a failed trade between said second record to said first record.

18. The engine of claim 17 wherein said records include a CUSIP; a contra party identifier; a net proceeds and a buy/sell indicator for a particular failed trade.

19. The engine of claim 18 wherein, as part of said search, said records have identical CUSIPs, opposite contra party identifiers, substantially equal net proceeds and opposite buy/sell indicators.
